(19) United States
(12) Patent Application Publication
(10) Pub. No.: US 2015/0199835 A1
(43) Pub. Date: Jul. 16, 2015

(54) TOOLS FOR CREATING DIGITAL ART

(71) Applicant: ART.COM, INC., Emeryville, CA (US)

(72) Inventors: Paul Golding, Cupertino, CA (US); Douglas Wayne Diego, Kensington, CA (US)

(21) Appl. No.: 14/668,875

(22) Filed: Mar. 25, 2015

Related U.S. Application Data
(63) Continuation-in-part of application No. 14/030,913, filed on Sep. 18, 2013.
(60) Provisional application No. 61/824,967, filed on May 17, 2013.
(60) Provisional application No. 61/809,832, filed on Apr. 8, 2013.
(60) Provisional application No. 61/809,802, filed on Apr. 8, 2013.

(51) Int. Cl. G06T 11/60; G06F 3/0484; G06T 13/80; G06F 17/21; G06F 17/24

(52) U.S. Cl. CPC G06T 11/60; G06F 17/212; G06F 17/24; G06T 13/80; G06F 3/0484; G06T 2200/24

(57) ABSTRACT

Disclosure is directed to a framework for creating a digital art. A digital art can include multiple digital assets, e.g., an image file, video file, computer generated imagery (CGI) file that can be used to generate various representations of the digital art. The digital art transforms from one representation to another in response to events, which can occur due to human interaction and/or a change in an attribute of a setting where a computing device displaying the digital art is installed. For example, a digital art depicting a bud of a flower can transform into a flower when the eyes of a viewer are focused at the bud for a specified duration. A user can define a transformation between digital assets by generating a link between two digital assets and specifying properties of the link, e.g., events upon which the transformation is to occur, transition features of the transformation.

### CROSS-REFERENCE TO RELATED APPLICATION(S)

This application is a continuation in part of U.S. application Ser. No. 14/030,913 titled “DISCOVERING AND PRESENTING DECOR HARMONIZED WITH A DECOR STYLE” filed Sep. 18, 2013, which claims the benefit of United States Provisional Application Serial Nos. 61/824,967 titled “DISCOVERING, VISUALIZING AND FACILITATING THE SELECTION OF ART, DESIGN, AND DECOR” filed May 17, 2013; 61/809,832 titled “DISCOVERING, VISUALIZING AND FACILITATING THE SELECTION OF ART, DESIGN, AND DECOR” filed Apr. 8, 2013; and 61/809,802 titled “DIGITAL ART SYSTEMS AND METHODS” filed Apr. 8, 2013, all of which are incorporated herein by reference for all purposes in their entirety.

### BACKGROUND

Artists have used canvas, oils or similar materials for image creation. Their art has remained within the confines of those tools. The tools have historically been one way tools, like books. The creator does not have a relationship with the viewer. The creator doesn't even know who the user is. The creator does not have tools to create images that match with a personality, mood, etc., of a user, that transform based on events such as gestures of a user, or that transforms based on attributes of an environment where the images are viewed. Further, current digital art devices show digital facsimiles of existing artwork, for example, created for canvas or other non-digital media. The user interaction with such art is limited to zooming in, zooming out, changing orientation, etc. The current tools lack abilities to create an art that can provide an interactive experience to a user, e.g., a viewer of the art.

Some of the art related applications that provide tools to create digital art, e.g., application programs developed using various programming languages, are inconvenient for an artist, who is seldom a computer programmer, to use them to develop the digital art. Some of the art related applications support limited media format, e.g., a still image (photo or digitally produced still media file), a video. However, plain video and/or images are of limited scope for highly creative and interactive digital art works. The support for a wide number of digital art pieces is greatly diminished by such applications.

### BRIEF DESCRIPTION OF THE DRAWINGS

One or more embodiments of the disclosed techniques are illustrated by way of example and not limitation in the figures of the accompanying drawings, in which like references indicate similar elements.

FIG. 1 is an example of an environment in which a smart digital art device may operate.

FIG. 2 is an example of an environment in which a digital art may be viewed or created on the smart digital art device, consistent with an embodiment of a disclosed technique.

FIG. 3 is a block diagram of a high level architecture of the smart digital art device of FIG. 1, consistent with an embodiment of a disclosed technique.

FIG. 4 is a flow diagram of a process for creating a digital art, consistent with an embodiment of a disclosed technique.

FIG. 5 is a flow diagram of a process of displaying a digital art using a digital art device of FIG. 1, consistent with an embodiment of a disclosed technique.

FIG. 6 is a flow diagram of a process of displaying a digital art using a digital art device of FIG. 1, consistent with an embodiment of a disclosed technique.

FIG. 7 is a flow diagram of a process of displaying a digital art using a digital art device of FIG. 1, consistent with an embodiment of a disclosed technique.

FIG. 8 is a flow diagram of a process of displaying a digital art using a digital art device of FIG. 1, consistent with an embodiment of a disclosed technique.

FIG. 9 is a flow diagram of a process of displaying a digital art using a digital art device of FIG. 1, consistent with an embodiment of a disclosed technique.

FIG. 10 is a flow diagram of a process of displaying a digital art using a digital art device of FIG. 1, consistent with an embodiment of a disclosed technique.

FIG. 11 is a flow diagram of a process of displaying a digital art using a digital art device of FIG. 1, consistent with an embodiment of a disclosed technique.

FIG. 12 is a flow diagram of a process of displaying a digital art using a digital art device of FIG. 1, consistent with an embodiment of a disclosed technique.

FIG. 13 is a flow diagram of a process of displaying a digital art using a digital art device of FIG. 1, consistent with an embodiment of a disclosed technique.

FIG. 14 is a flow diagram of a process of generating a real-play media file for a digital art, consistent with an embodiment of a disclosed technique.

FIG. 15 is a block diagram of an example of a digital art, consistent with an embodiment of a disclosed technique.

FIG. 16 is a block diagram of a process for creating a digital art using the digital art creator app of FIG. 2, consistent with an embodiment of a disclosed technique.

FIG. 17 is a flow diagram of a process for creating a digital art using a digital art creator app of FIG. 2, consistent with an embodiment of a disclosed technique.

FIG. 18 is a flow diagram of a process for displaying a digital art that is generated using a digital art creator app of FIG. 2, consistent with various embodiments.

FIG. 19 is a block diagram of a computer system as may be used to implement features of some embodiments.

### DETAILED DESCRIPTION

Disclosed here are methods, systems, paradigms and structures for providing a framework to create a digital art that can transform to various representations based on user interaction. In some embodiments, a digital art is an art work that includes various representations or states, and transforms from one representation to another in response to events. The events can occur due to human interaction and/or due to a change in one or more attributes of a setting/an environment/a room where a computing device displaying the digital art is installed. Some interactions that can generate an event include a viewer looking at a particular portion of the digital art for a specified duration, a particular time of the day, a particular room temperature of the setting, an intensity of light in the setting, etc.

The digital art can transform from one representation to another representation upon an occurrence of an event. For example, consider a digital art that depicts a bud of a flower displayed on a computing device. The bud can transform into a flower when a viewer looks at the bud for a specified duration. That is, the digital art transforms from a first representation, which depicts the bud, to a second representation, which depicts the blossomed flower, upon an event such as the viewer looking at the bud for a specified duration. The digital art can have various such representations which can be displayed based on various events.

The digital art can be a collection of a number of digital assets, which can be used to generate various representations of the digital art. A digital asset can be a multimedia file, e.g., an image file, a video file, an audio file, a computer generated imagery (CGI) file. When a digital art transforms from one representation to another, it can transform from one digital asset to another. In some embodiments, a representation of the digital art is generated using a single digital asset or a group of digital assets. Continuing with the above example of the digital art depicting the bud transforming into the flower, the representation depicting the bud can be one digital asset, e.g., an image file, and the representation depicting the flower can be another digital asset, e.g., image file. In another example, the representation depicting the flower can be a video file that displays a video of the bud blossoming into the flower, when the event occurs. In some embodiments, a representation of the digital art is generated using multiple digital assets. For example, the representation depicting the flower can be a set of digital assets, e.g., a set of image files, each of which depict a particular stage in the blossoming of the flower, that when displayed one after the other at a specified speed, displays the bud gradually blossoming into the flower.

In some embodiments, various representations of the digital art can be generated using a single digital asset. For example, the digital art depicting the bud transforming into the flower can be a CGI file. The CGI file can be programmed such that the digital art showing a bud in a first representation can transform, e.g., on occurrence of an event, to a second representation showing the flower.

The framework provides a digital art creator application (digital art creator app) that can be used by a user, e.g., an artist, to create a digital art and/or define transformations between representations of the digital art. In some embodiments, the digital art creator app provides a “drag and drop” graphical user interface (GUI) that can be very simple and easy to use for an artist. The artist may use the GUI with minimum to no expertise in computer programming. In some embodiments, defining transformations can include one or more of defining a sequence in which the various digital assets are to be displayed, e.g., transform from one asset to another asset and defining the events based on which the transformations between the assets are to occur. The digital art creator app can also facilitate defining transition features of a transition from one asset to another, e.g., audio and/or visual effects, such as a cross fade effect, burns effect, a speed at which a video is to be played, etc.

In some embodiments, the user can define the transformations between the digital assets of the digital by generating navigational links between the digital assets. A navigational link includes various properties of a transformation. For example, the navigational link includes a source digital asset from which the digital art is to transform from and a destination digital asset to which the digital art is to transform. The navigational link can be associated with various events, which identify the condition based on which the transformation from the source digital asset to the destination digital asset of the navigational link is to occur. A digital asset can have a number of navigational links, each of them transforming to different destination digital assets of the digital art. Further, different navigational links can be associated with different events.

In some embodiments, the GUI of the digital creator app can provide tools to create the navigation links. For example, the user can create a navigational link by drawing a connector from the source digital asset to the destination digital asset, and can further associate the connector with the properties of the transformation. Note that the navigational links can be defined in various ways. In some embodiments, the navigational link can be generated as a data object in the digital art creator app, which includes a number of attributes indicating the properties of the transformation.

In some embodiments, the digital art creator app facilitates creation of digital assets of the digital art. For example, the digital art creator app can provide various drawing tools to create the images, such as an image of the bud of the above discussed digital art. In some embodiments, the user can use the digital assets created using a third party tool and define the transformations, the events based on which the transformations are to occur and the transition features using the digital art creator app.

In some embodiments, the computing device used to display the digital art includes a smart digital art device (also referred to as “art installation,” “digital art device” or “device”). The digital art device includes various sensors such as camera, gyroscopes, microphone, audio processor, photometer, eye-tracking sensors, etc., to identify various types of human interaction, and to identify various attributes of the setting. A digital art displayed in the device can be transformed in accordance with the relationship to a viewer or the setting. That is, the digital art device can process, change, adapt, display or transform the digital art according to the observed human interaction and/or the observed attributes of the setting. The digital art can be associated with various events and actions, e.g., as defined by the navigation links. In some embodiments, the actions can include transforming to a digital asset specified by a navigational link associated with the event. In some embodiments, the actions can include changing the attributes of the digital art device, e.g., decreasing the brightness of a screen of the digital art device, changing the color of a frame of the digital art device, etc. The digital art device can process the input received from various sensors, generate events and process, transform and/or display the digital art based on the actions associated with the events.

A digital art software development kit (SDK) allows developers to create applications (a) that can be used by artists to create digital art to be viewed on the digital art device and (b) that can be used to display various types of digital art on the digital art device. The developers can access underlying décor discovery and visualization tools that are able to process color, style and other décor-related attributes. The capabilities of the digital art device and the décor discovery and visualization tools can be exposed as an application programming interface (API) in the applications created for the digital art device. In this way, developers can extend the types of digital art experiences that can be installed on and viewed via the digital art device. Users of the digital art device can download and install these applications on the digital art device in order to display new types of digital art media experiences.

### Example Environment

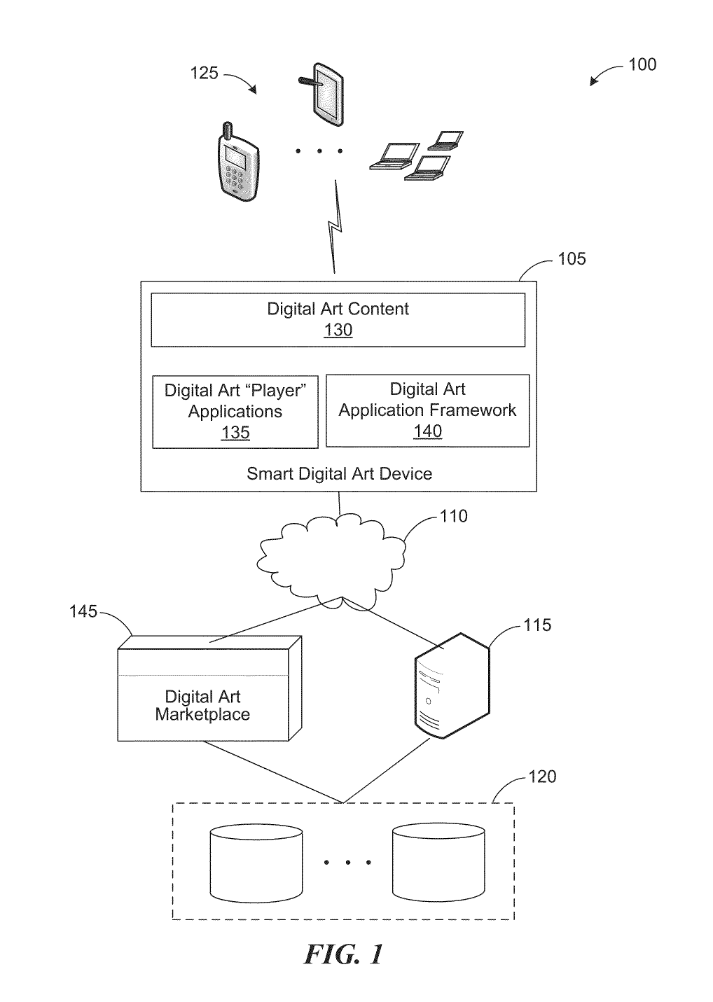

FIG. 1 is an environment in which a digital art device may operate, according to an embodiment of the disclosed technique. The environment 100 includes the digital art device 105 that can be used to create and display digit art content 130 such as images. The device 105 includes a digital art application framework 140 that allows the user to load and run applications (also referred to as “app”) such as digital art player app 135 for viewing digital art content 130 and controlling the user interface of the device 105. The digital art application framework 140 provides as a platform on which the applications can run on the device 105. The digital art player app 135 enables the user to browse digital art content 130 and applications, such as digital player apps, applications for creating the digital art, stored in a digital art marketplace 145 running on a remote server such as server 115. In some embodiments, some of the digital art content 130 can be stored at the database 120. In some embodiments, some of the applications can be stored at a local storage device associated with the digital art device 105.

For example, the digital art marketplace 145 can have a digital player app that enables a user to view digital “time-lapse” art. In some embodiments, a digital time-lapse art is an art that evolves slowly over time, such as a tree that grows from day to day, or changes with the seasons. To view the “time-lapse” art, the user may download the time-lapse app from the digital art marketplace 145. After the time-lapse app is installed on the digital art device 105, the user can use the time-lapse app to access app-specific (i.e. “time lapse”) digital art content 130 in a content catalogue, such as a plurality of databases 120, associated with the digital art marketplace 145. Once the time-lapse app is downloaded to the digital art device 105 and installed, the device 105 could continue to access digital art content 130 directly from the database 120 in order to access content updates (e.g. time lapsed sequences downloaded periodically).

The digital art device 105 displays media based on a variety of user interactions and/or based on the characteristics of a setting, e.g., a room, where the digital art device 105 is installed. The user may interact with device 105 using a number of client devices 125 such as a smart phone, tablet computer, laptop, desktop, etc. The user may also interact with the device 105 using a touch screen of the device 105. The database 120 stores art works, user profiles that are used to personalize images, artist information, color palettes, etc. The server 115 acts as a gateway for communicating with the database 120. The server 115 also facilitates in performing searching of digital art, non-digital art, and can include software such as CGI applications and various other plug-ins necessary for providing the above digital art experience to the user, e.g., creating digital art, playing digital art. Certain other software, including digital art player apps, digital art content creator apps, may also be downloaded from the digital art market place 155 to the device 105.

The device 105 communicates with the server 115 over a communication network 110. The communication network 110 includes wide area network (WAN), local area network (LAN), Internet, or such other similar networks. The connection between the device 105 and the communication network 110 and between server 115 and the communication network 110 can be wired or wireless.

Various content providers, e.g., artists, can download the digital art creation apps from the digital art marketplace 145 onto their user devices, e.g., a desktop, a laptop, a smart phone, a tablet pc, digital art device 105, and use the apps for creating the digital art. The artist can also define one or more events and associated actions for the digital art. An action defines a process to be performed upon an occurrence of an event. After creating the digital art, they can publish the digital art in the digital art marketplace 145. In some embodiments, the artists provide their digital arts to publishers who publish digital arts obtained from various artists to the digital art marketplace 145. The users can buy the digital arts from the digital art marketplace 145 for displaying at their digital art devices. Users can also subscribe to a particular artist and any updates from the artist, e.g., a new digital art published to the digital art marketplace 145, can be transmitted to the users, e.g., at their digital art devices.

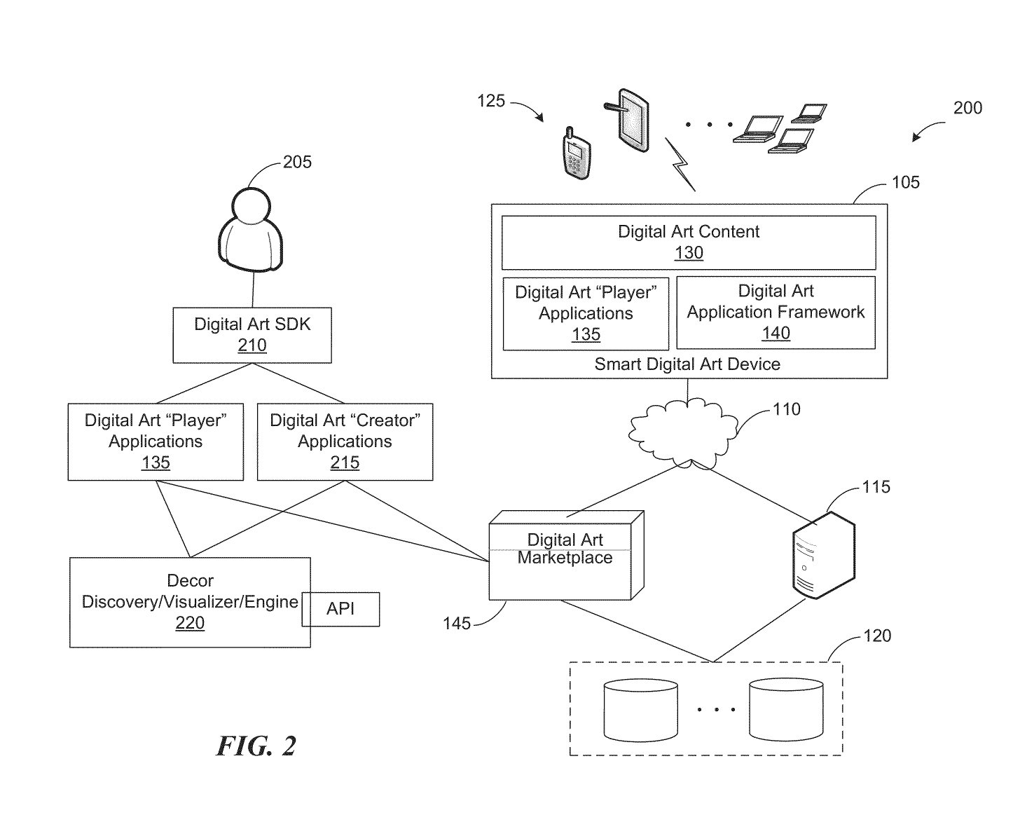

FIG. 2 is an environment in which digital art content and digital art applications are created for a digital art device of FIG. 1, according to an embodiment of the disclosed technique. The environment 200 includes the digital art device 105 that can be used to create and display digit art content 130 such as images, and create other digital art applications for facilitating creation and display of digital art content 130.

A developer such as developer 205 can use a digital art SDK 210 to build applications such as digital art player app 135 to view digital art content 130, digital art creator app 215 to create digital art content 130, and any other apps that can run on the digital art device 105. The digital art SDK 210 allows the user to exploit full capabilities of the digital art device 105 so that the developer 205 can produce applications that enable the content producers, e.g., artists, to produce digital art content 130. For example, the developer 205 could develop an application that provides the tools for the artist to create time-lapse art.

Further, in an embodiment, using the digital art SDK 210, the developer 205 will also be able to access décor visualizer/engine/discovery tool 220. The décor visualizer/engine/discovery tool 220 will enable the apps to gain access to features that include the ability to discover, visualize and analyze décor items stored in databases, including digital art content 130. For example, the developer 205 can create an app that uses one of the sensors on the digital art device 105, e.g., a camera, to identify the colors in the room where the digital art device 105 is situated, to generate a color palette for the room. The décor engine 220 can then be used to find digital art content 130 that matches the color of the room. The apps can access the features of the décor visualizer/engine/discovery tool 220 using the API on the décor visualizer/engine/discovery tool 220. After creating the apps, the developer 205 submits the apps to the digital art marketplace 145. The apps are made available to the users upon approval by an entity managing the digital art marketplace 145.

Content creators, e.g., an artist, can use the available apps, e.g., digital art creator app 215, from the digital art marketplace 145 to create content. The content creator can then upload the digital art content 130 to the digital art marketplace 145 which stores the digital art content 130 in the database 120. Upon approval by the entity managing the digital art marketplace 145, the digital art content 130 is made available to users to consume via the appropriate digital player art app 135.

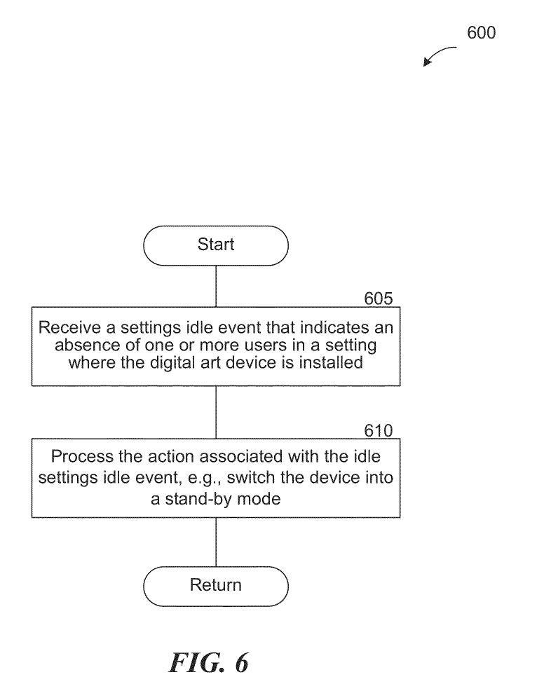

The digital art creator app 215 enables the artist or provides the artist with a set of tools to allow all of the features of the device 105 (which are described in additional detail at least with reference to FIGS. 6-13), such as eye-tracking, gesture control, sound matching, color-matching, face recognition, to be exploited during the digital creation process. In an embodiment, the set of tools can be provided as plug-ins or extensions which can be installed into existing art related applications, such as the Adobe Creation Suite from Adobe of San Jose, Calif. However, in other embodiments, the tools may be developed as new software that can be installed on the device 105. In some embodiments, the digital art creator app 215 can also be used on a computing device, e.g., a laptop, a desktop, a smartphone, a tablet, to create the digital art.

The user of the device 105 is given the option to “follow” artists so that any updates are automatically made available for showing on the device. This includes following the real-time construction of new digital arts so that a user can watch the construction from beginning to end at the same rate as the artist creates the digital art. The digital art player app 135 supports “super slow-motion” updates that enable the artist to produce a digital art that changes very slowly (for example, over days, weeks or even months) so that the digital art evolves on the display and becomes a “living” work of art that generates anticipation for the user. This provides a way to achieve dynamic image capabilities for a display of the device 105, such as e-ink display, that has a relatively low refresh rate. This can also be a way to achieve dynamic images without consuming a lot of power.

Further, the digital art creator app 215 can enable the artists to create, using particle physics, algorithms to control the “flow” of digital paint via the trajectory of paint particles, for example, spirals, splashes, swathes, trickle and so on. Different artists can construct libraries of different flow patterns. Users can subscribe to various complete pattern sets that represent a finished work by an artist, or they can combine different sets to create their own works. This allows unique abstract works to be created according to user preference and experimentation. The digital art player app 135 can then display digital arts that have these flow patterns on the digital art device 105.

### Digital Art Device Architecture

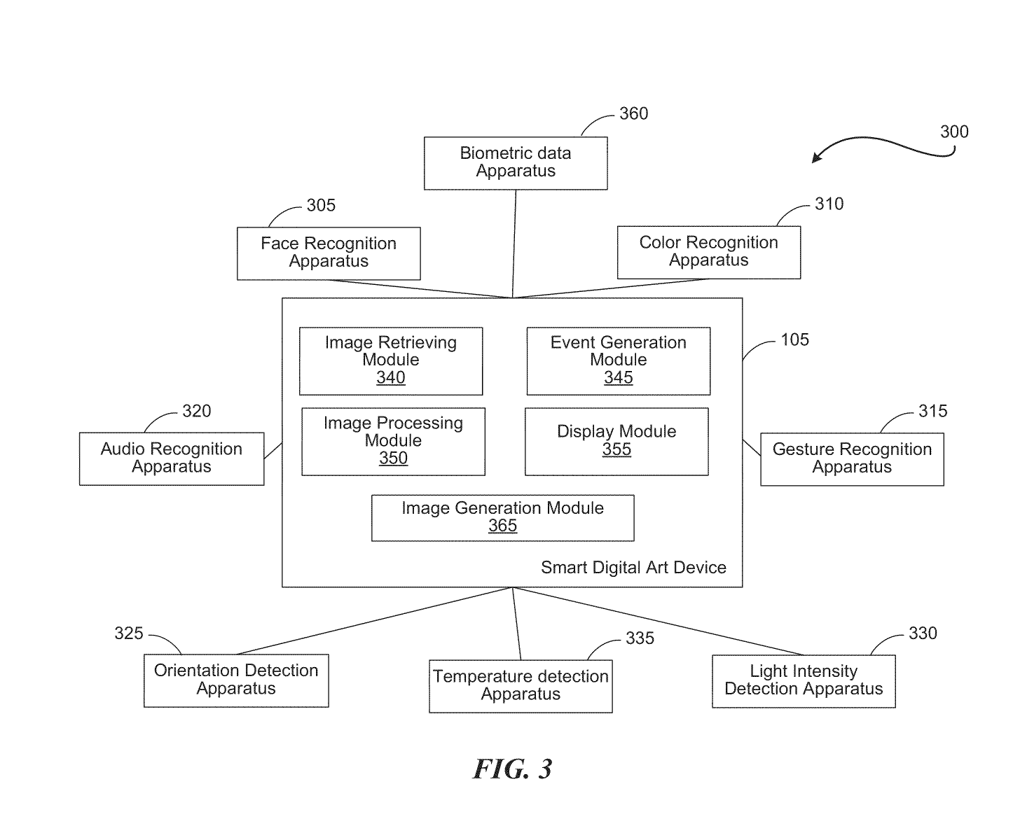

FIG. 3 is a block diagram of the digital art device of FIG. 1, according to an embodiment of the disclosed technique. The digital art device 105 supports creating or displaying a digital art, e.g., digital art content 130, based on a number of user interaction features, features of the setting and/or features of the device. The digital art device 105 includes a number of sensors, e.g., a face recognition apparatus 305, a color-recognition apparatus 310, a gesture recognition apparatus 315, an audio recognition apparatus 320, an orientation detection apparatus 325, a light intensity detection apparatus 330, a temperature detection apparatus 335, for capturing various user interactions and attributes of the setting and/or the digital art device 105.

In some embodiments, the face recognition apparatus 305, color-recognition apparatus 310 and the gesture recognition apparatus 315 include one or more cameras. Further, in some embodiments, each of the face recognition apparatus 305, color-recognition apparatus 310 and the gesture recognition apparatus 315 have cameras of different configurations. In some embodiments, the light intensity detection apparatus 330 includes a photometer. In some embodiments, the orientation detection apparatus 325 includes a gyroscope. In some embodiments, the temperature detection apparatus 335 includes a thermometer.

The face recognition apparatus 305 can be used to recognize the person facing the device 105. The color-recognition apparatus 310 can be used to identify the color scheme of the room décor. The gesture recognition apparatus 315 can be used to identify the gestures made by the user facing the device 105. The audio recognition apparatus 320 can be used to identify the voice commands of the user or music, sound, ambient noise in the setting where the device 105 is installed. The orientation detection apparatus 325 can be used to determine the orientation of the device 105. The light intensity detection apparatus 330 can be used to determine the lighting conditions and levels in the setting where the device 105 is installed. The temperature detection apparatus 335 can be used to determine the temperature in the setting where the device 105 is installed. The device 105 uses the data received from one or more of the above sensors in displaying an appropriate digital art and/or in altering or transforming the digital art already displayed on the digital art device 105 to another digital art.

The device 105 includes an event generation module 345 that generates an event based on the data received from the sensors. For example, the event generation module 345 generates an orientation event when the orientation of the device 105 changes. In another example, the event generation module 345 generates a gesture control event when a user performs a gesture at the device 105.

The device 105 includes an image processing module 350 that processes the various events to perform the associated actions and generate the transformed digital arts. For example, for an orientation event, an artist-defined action can be to tilt a portion the digital art accordingly when the device is tilted. The image processing module 350 processes the digital art displayed in the device 105 to tilt the portion of the digital art, e.g., by retrieving a representation of the digital art containing the tilted portion or retrieving a new digital art that contains the tilted portion of the displayed digital art. The image processing module 350 communicates with the image retrieving module 340 to retrieve the new digital art and/or the representation containing the tilted portion, which can be stored in a storage system such as database 120, and notifies a display module 355 to display the transformed digital art. In another example, the user can perform a gesture to zoom a particular portion of the digital art displayed on the device 105. The event generation generates a gesture event and notifies the gesture to the image processing module 350. The image processing module 350 can then process the digital art to generate the transformed image, e.g., retrieve a representation of the digital art containing a zoomed-in view of the identified portion or obtain a new digital art to display the zoomed-in view. That is, the image processing module 350 facilitates obtaining of an appropriate image based on the user interactions, or properties of the device or the properties of the setting and displaying the image on the device 105. Additional details with respect to various features of the digital art device 105 and how the events are processed are described at least with reference to FIGS. 6-13 below.

The device 105 also includes an image generation module 365 that can be used to generate digital art. For example, the digital art creator app 215 can be implemented or executed using the image generation module 365. The image generation module 365 can also implement some or all portions of the digital art app framework 140.

Although the diagrams depict components as functionally separate, such depiction is merely for illustrative purposes. It will be apparent to those skilled in the art that the components portrayed in this figure can be arbitrarily combined or divided into separate components. Further, although the device is described with reference displaying or creating a digital art image, the device may also be used to create and display images of non-digital art. However, the advantages obtained by exploiting the user interactions with the digital art may not be obtained with non-digital art.

The digital art device 105 itself can be designed to look like an art work. The digital art device 105 is an electronic display that enables images to be displayed for the purposes of wall decoration. The digital art device 105 can include, for example, e-paper that is not restricted to be flat or rectangular, can be made from materials or combination of materials such as e-paper laminated by transparent LED matrices, etc. The digital art device 105 can be integrated into other décor or construction materials, such as the wallpaper or wall panels (e.g. low cost LEDs glued close beneath the surface of a wall panel, sufficient to shine through the panel, which can be used for both art and lighting purposes). The device 105 can also include bio and chemical luminescence materials, that is, materials that can effuse light.

The frame of the device 105 can also be made from a display material so that it can display different frame colors and textures on command, which could be used to match the frame to the surrounding décor or to the user's current tastes. The edge of the device contains a skirt of LED arrays that can project light onto the wall to enable the color of the image to “bleed” out to the surrounding décor.

The device 105 can include a replaceable and rechargeable battery that can be inserted into the side of the frame. The device 105 can be designed to be a portable device so that it can be removed from one place and installed in another place easily.

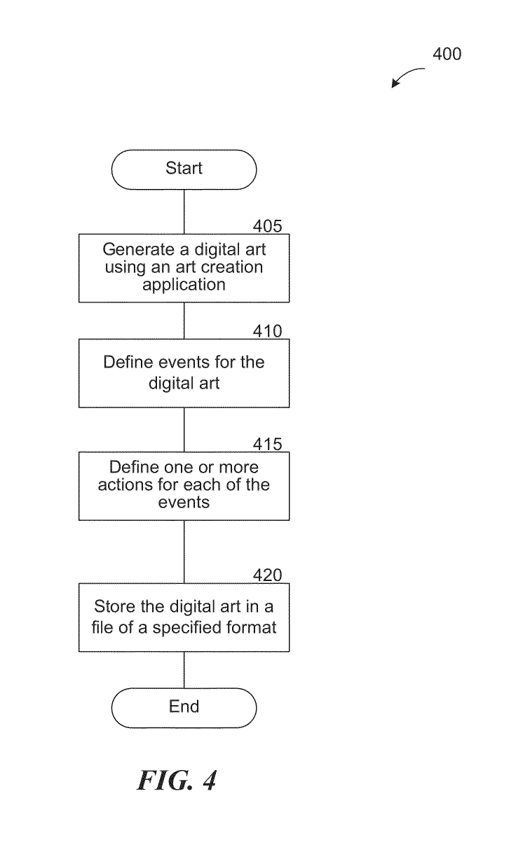

FIG. 4 is a flow diagram of a process 400 for creating a digital art consistent with an embodiment of a disclosed technique. The process 400 can be implemented in an environment 100 of FIG. 1. The process 400 can be executed at the digital art device 105 and/or other user devices, e.g., a desktop, a laptop, a tablet, etc. A content provider, e.g., an artist, can use a digital art creator application, e.g., digital art creator app 215 of FIG. 2 downloaded from the digital art marketplace 145 for creating a digital art. At block 405, the artist generates a digital art using the digital art creator app 215.

At block 410, the artist defines one or more events, e.g., a gesture control event, a face recognition event, an orientation event, an eye tracking event, etc., for the digital art. The digital art device 105 can generate these defined events based on the data received from the sensors.

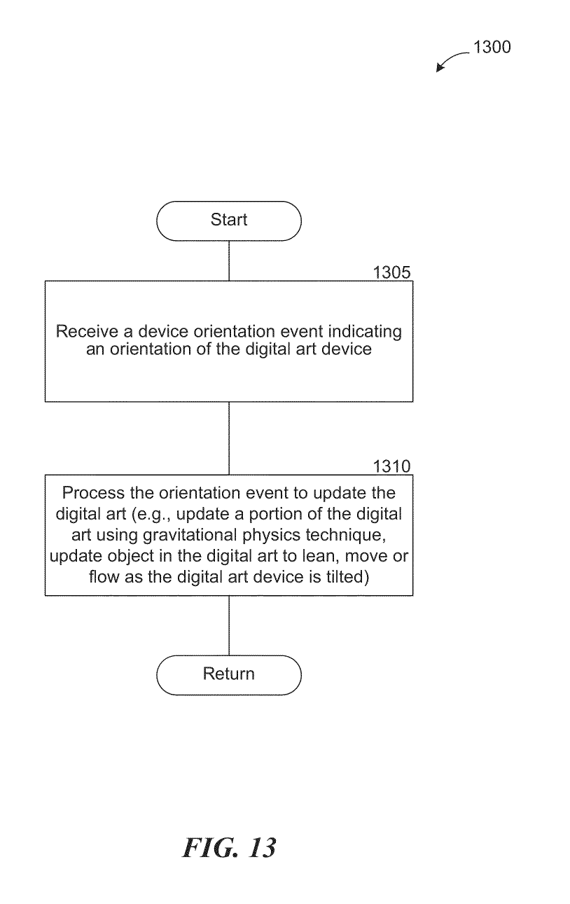

At block 415, the artist can define one or more actions for each of the events. For example, an action for an orientation event for a particular digital art can be to tilt the digital art or a portion of the digital art based on the orientation. Additional details with respect to the orientation event and the action associated with the orientation event are described at least with reference to FIG. 13 below.

In some embodiments, some of the events and the actions can be defined by the digital art device 105 itself. For example, one of the predefined events can be to generate an event when an intensity of light in a setting where the digital art device 105 is installed drops below a threshold or exceeds a specified threshold and the associated action can be to increase or decrease a brightness of the screen accordingly. The predefined events can be customized, e.g., enabled, disabled, and modified, by the user of the digital art device 105.

After the digital art is generated, at block 420, the artist can save the digital art into a media file. The media file can be of a specific format, e.g., a format that can be displayed on the digital art device 105 using the digital art player app 135. The media file can be published to the digital art marketplace 145.

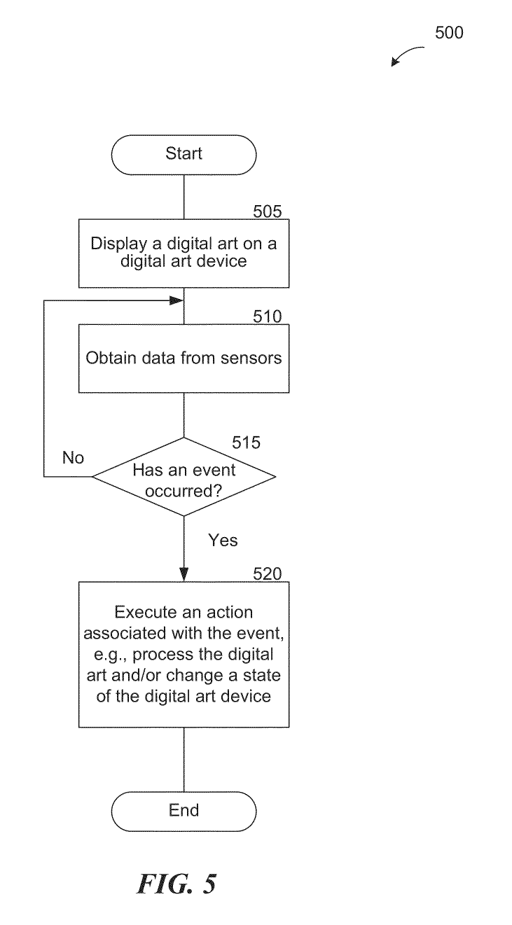

FIG. 5 is a flow diagram of a process 500 of displaying a digital art using a digital art device of FIG. 1, consistent with an embodiment of a disclosed technique. At block 505, a display module 355 of the digital art device 105 displays a digital art at the digital art device 105, e.g., on a screen of the digital art device 105. In some embodiments, the display module 355 notifies an image retrieving module 340 to retrieve a digital art for displaying. The image retrieving module 340 communicates with the image processing module 350 to determine the digital art to be obtained and obtains the digital art from a storage system, e.g., digital art marketplace 145, a local storage device associated with the digital art device 105.

At block 510, the event generation module 345 obtains data from one or more of the sensors associated with the digital art device 105, e.g., sensors 305-335 of FIG. 3. The event generation module 345 processes the data received from the sensors to determine whether an event has to be generated. For example, if the sensor data indicates that the orientation of the device 105 has changed, a user has performed a gesture, etc., the event generation module 345 generates an event.

At determination block 515, the image processing module 350 determines whether an event is generated. Responsive to a determination that no events are generated, the control transfers to block 510 where the process 500 continues obtain data from the sensors. On the other hand, responsive to a determination that an event is generated, at block 520, the image processing module 350 triggers/executes the action associated with the event. Executing the action associated with the event can include processing the digital art displayed at the digital art device.

In some embodiments, processing the digital art can include transforming the digital art to display a second representation of the digital art from a first representation. In some embodiments, processing the digital art can include transforming the digital art to display a new digital art that is different from the already displayed digital art. For example, for a digital art depicting some fruits placed on a table, consider that for a first orientation, a first representation of the digital art depicts the table in a first position and the fruits in a particular position on the table, and for a second orientation, a second representation of the digital art depicts the table as tilted from the first position and fruits as moved or rolled from the particular position. The artist might have created a single digital art to depict the states at both orientations. For example, if the artist has generated the digital art using CGI techniques, the digital art in a state of the first orientation can be programmed to transform to a state of that of the second orientation upon the occurrence of the event.

In some embodiments, processing the digital art can include retrieving a new digital art from the storage system and displaying the new digital art. Continuing with the above example of the digital art depicting some fruits placed on the table, the digital art for the second orientation can be a digital art different from that of the first orientation, e.g., a digital art depicting a coffee cup. That is, the artist can have created two different digital arts, one for the first orientation and another one for the second orientation.

Further, in some embodiments, executing the action associated with the event can include changing a state of the digital art device. For example, if a gesture event such as a gesture for switching off the device is generated, the action corresponding to the event can be to power off the device 105. In another example, on occurrence of an “idle setting” event, which indicates that no one is present in the room where the device 105 is installed, an action for switching the device 105 to a stand-by mode, a low-power consumption state, or for decreasing he brightness of the screen of the device, etc., can be executed.

The following paragraphs describe examples of various events and actions that can be defined for the digital art device 105.

### Power Saving Feature

The device 105 detects when someone is in the room and can alter its behavior accordingly, such as only displaying media when there is someone to view it, or displaying the image in low brightness when there is no one in the room, etc., thereby saving power.

FIG. 6 is a flow diagram of a process 600 of displaying a digital art using a digital art device of FIG. 1, consistent with an embodiment of a disclosed technique. In some embodiments, the process 600 can be executed as part of the process indicated by blocks 515 and 520 of the process 500 of FIG. 5. At block 605, the image processing module 350 receives a “settings idle” event from the event generation module 345 indicating that there are no people in the setting where the digital art device 105 is installed.

At block 610, the image processing module 350 processes an action associated with the settings idle event. For example, the action can be to switch the device to a low power state, a stand-by mode, or decrease the brightness of the screen. In some embodiments, the low power-state or the stand-by mode can be a mode where a display of the device 105 is turned off and a processor of the device 105 (not illustrated) is put in a low-power consumption mode, some of the sensors are powered off, etc. In another example, the action can be to display a screensaver that blanks the screen of the digital art device 105 or fills it with moving images or patterns.

The event generation module 345 can determine whether there are no people in the settings based on the data received from the sensors. For example, if the cameras of the digital art device 105 do not detect any people in the setting near the digital art device 105, the event generation module 345 can determine that there are no people in the setting, and can generate a settings idle event. A user associated with the digital art device can customize the generation of the settings idle event. For example, the user can define a duration for which the sensors have to detect the absence of people before the event generation module 345 can determine to generate the settings idle event. In another example, the user can also define a specified area in the setting where the sensors have to detect for presence or absence of people for the event generation module 345 to determine whether to generate the settings idle event.

### User Identification—Face Recognition/Audio Recognition

Using person identification techniques such as facial recognition, the device 105 can change the contents to suit the interests of the person facing the display of the device 105. The device 105 can store profiles for different users in order to understand image preferences.

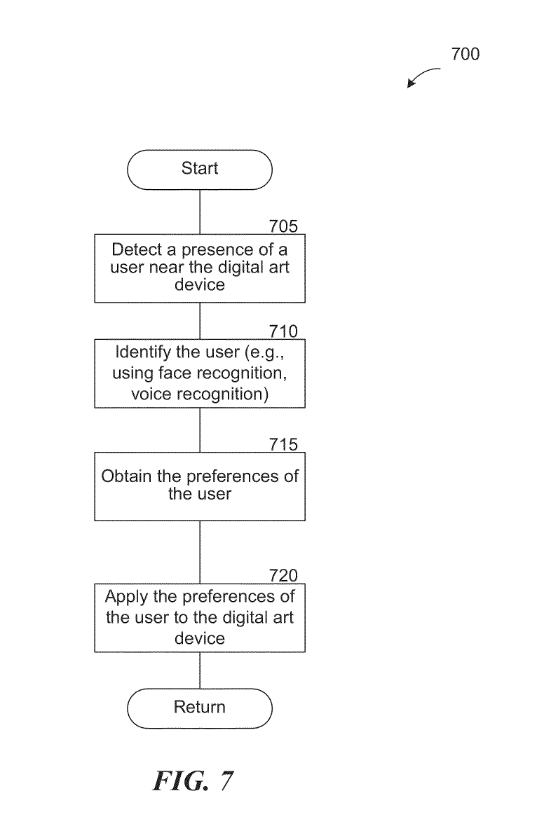

FIG. 7 is a flow diagram of a process 700 of displaying a digital art using a digital art device of FIG. 1, consistent with an embodiment of a disclosed technique. In some embodiments, the process 700 can be executed as part of the process indicated by blocks 515 and 520 of the process 500 of FIG. 5. At block 705, the image processing module 350 receives a “user identification” event from the event generation module 345 indicating a presence of a user in the proximity of the digital art device 105. In some embodiments, the event generation module 345 determines the presence of the user based on image data of the user received from the face recognition apparatus 305, audio data of the user received from the audio recognition apparatus 320, or other user related data, e.g., biometric data, received from a biometric apparatus 360.

At block 710, the image processing module 350 identifies the user based on the data received from the sensors. For example, the digital art device 105 can maintain user profiles for various users, which includes data necessary for identification of the users and also preferences of each of the users. The image processing module 350 identifies the user by matching the user related data received from the sensors, e.g., image of the face of the user, audio data of the user's voice, retina of the user's eye, fingerprint, with the user profile data.

At block 715, the image processing module 350 obtains the preferences of the user. The preferences can include one or more of the digital arts to be displayed to the user, the type of digital arts to be displayed, the events to be generated, the type of actions to performed for a particular event, a configuration of the digital art device 105, e.g., a particular brightness level of a screen of the device 105, a volume level of the speakers, an orientation of the device 105, etc.

At block 720, the image processing module 350 applies the preferences to the digital art device 105.

### Eye-Tracking Technology

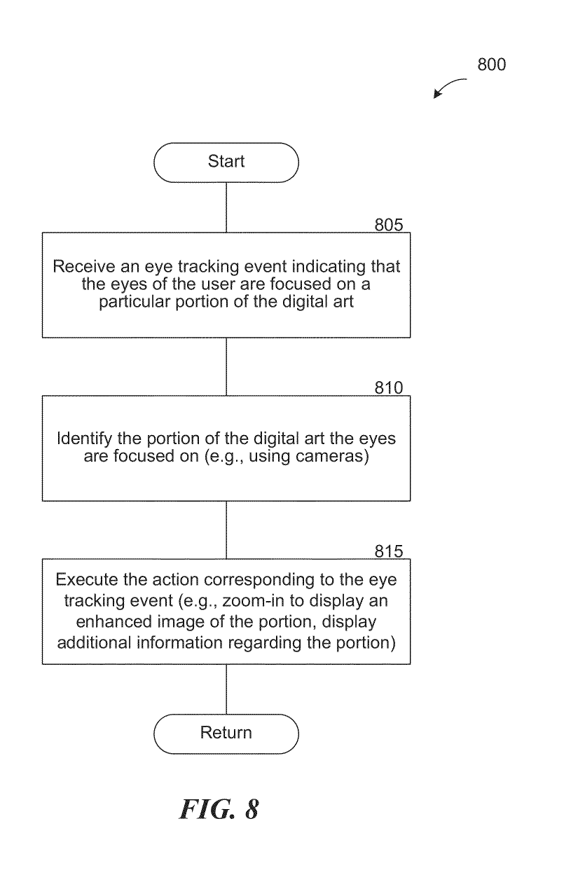

FIG. 8 is a flow diagram of a process 800 of displaying a digital art using a digital art device of FIG. 1, consistent with an embodiment of a disclosed technique. In some embodiments, the process 800 can be executed as part of the process indicated by blocks 515 and 520 of the process 500 of FIG. 5. At block 805, the image processing module 350 receives an eye tracking event from the event generation module 345 that indicates a portion of the digital art the user is looking at. For example, the cameras can track the eyes of the user and identify the co-ordinates of the digital art device 105 the eyes are focused, which can be further used by the image processing module 350 to determine a portion of the digital art displayed on the digital art device 105 the eyes are focused at.

At block 810, the image processing module 350, determines a portion or a spot in the digital art the eyes of the user are focused at. At block 815, the image processing module 350 executes an action associated with the eye tracking event. The action can be any activity defined for the event, e.g., by an artist who created the digital art. Further, the way in which the digital art is altered or enhanced depends on how the artist who created the digital art wishes to exploit the eye-tracking feature. In some embodiments, the action can be to display additional formation regarding the identified portion. For example, if the person is looking at a watch in the wrist of a person in the digital art, additional details like brand of the watch, can be displayed with the digital art. In some embodiments, the action can be to alter the identified portion of the image, such as enhancing the level of detail in that part of the digital art. For example, by staring at a flower in a landscape depicted in a particular digital art, the flower might blossom. This can be achieved by, for example, retrieving a representation of the particular digital art that has a blossomed flower. Further, when looking at a particular point on the display, the viewer is able to “drill down” into underlying layers, either to show additional textures or details that the artist has embedded.

One artistic possibility is for “one way” condition animation or “entropic evolution” of the digital art whereby the changes to the digital art are irreversible—there is no reset available. The digital art will change in accordance with where the user has looked and for how long, and the digital art changes can be “randomized” under the artist's control. The device 105 renders a unique digital art that has an “imprint” of the user's gaze and interest. The digital art becomes a unique relationship between the artist and the viewer. Using a combination of viewer-detection and eye-tracking, the digital art can alter its state according to a combination of viewer interests.

### Gesture Control

The device 105 allows the user to interact with the device 105 using gesture controls. The device 105 supports the ability for the user to point or look at objects within the digital art displayed on the device 105, such as a vase, a tree or a shape, in order to select them. The device 105 also allows the users to interact with the device 105 to change the behavior or attributes of the device 105. In some embodiments, the gestures include hand-gestures, posture of the body, etc. The gesture recognition apparatus can include a camera such as the one used as eye tracking device.

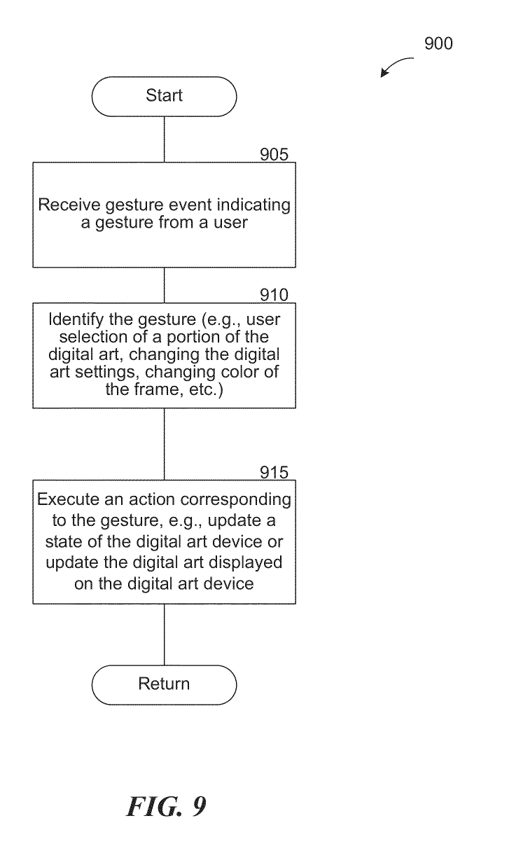

FIG. 9 is a flow diagram of a process 900 of displaying a digital art using a digital art device of FIG. 1, consistent with an embodiment of a disclosed technique. In some embodiments, the process 900 can be executed as part of the process indicated by blocks 515 and 520 of the process 500 of FIG. 5. At block 905, the image processing module 350 receives a gesture event from the event generation module 345 indicating a gesture from the user. At block 910, the image processing module 350 identifies the gesture. The gesture can include user selection of a portion of the digital art displayed in the device 105, an indication to change the settings of the device 105, an indication to display a next digital art from a set of digital arts, etc.

At block 915, the image processing module 350 executes an action corresponding to the gesture event. In some embodiments, the gesture can be an indication to update the state of the digital art device. For example, the gesture can be an indication to change the brightness of the screen of the device 105, for which the corresponding action can be to update the brightness. Accordingly, when the action is executed, the image processing module 350 can update the brightness of the screen.

In some embodiments, the gesture can be a user selection of a portion of the digital art displayed on the device 105. After the user has selected the portion, a number of actions can be performed, e.g., displaying additional information regarding the selected portion, searching for other digital arts that match the selected portion. As described above, an action performed for the event can be any action that is defined for the event, e.g., by an artist of the digital art, the user of the digital art device 105. For example, after the user has selected an object in the digital art, the user can then request the device 105 to show more digital arts with similar objects, using the selected objected in the digital art as a means to search various sources, e.g., database 120, to find a new digital art. The objects in the image are automatically detected using, for example, pattern recognition software and are used to create an “object mask” over the image.

### Searching

The criteria for determining a match between two digital arts or a portion of thereof can be defined in many ways. In some embodiments, a match is determined based on one or more colors of the digital arts, a shape of the digital arts, a category the digital arts are classified into, a name of the artist of the digital arts, a theme, a concept, an occasion or a mood depicted by the digital arts, etc. For example, two digital arts can be determined to match if one or more of their colors are the same or similar (the artist or even the user can define the criteria for determining if two colors are similar). In another example, two digital arts can be determined to match if they are classified into the same category, e.g., abstract art. The criteria for determining the match can be defined by various entities, e.g., the artist, the user of the device 105. In some embodiments, a third party such as interior decorators can be hired to define the matching criteria for matching the digital arts.

The user can use his or her finger to draw shapes or paint using various colors on a blank canvas displayed in the device 105, and then use these to search various sources, e.g., the database 120, for digital arts with a similar shape or color scheme. For example, the user could create an orange streak and then a black box and request the digital art player app 135 on the device 105 to search for images with similar shapes or colors. Further, the digital art player app 135 can also support “literal” searching. For example, the user can draw what he/she believes to be hills with trees and the sun in a particular position. The digital art player app 135 then searches for digital arts that seem to literally match the configuration, that is, the sun in the position shown, the hills and so on. The digital art player app 135 can also be used for “shape-based” search, such as the vase example above (all digital arts with vases). The digital art player app 135 can also be used in an “inspiration mode” where the orange/black lines mentioned earlier represent the user's intent to find something with orange and black lines, no matter what that image might be. In the inspiration mode, the user can request different color palettes on the display and use these to search for digital arts with similar palettes.

In some embodiments, the digital art player app 135 facilitates searching for digital arts based on a mood of the person. The applications, e.g., the digital art creator app 215, the digital art player app 135, enable an artist or other users to associate a digital art with one or more of the moods from a mood dictionary, e.g., calm, bold, happy, busy, party. The mood dictionary is generated and updated regularly based on data like user-preferences of digital art for particular moods, mood description, association of colors to a particular mood, data from other sources such as decor books, interior design books, etc.

It should be noted that while the digital art player app 135 facilitates searching of digital arts, the search is not restricted to digital arts. The digital art player app 135 can also facilitate searching for non-digital arts. The colors in the non-digital art images can be automatically determined using known color recognition techniques. The objects in the non-digital art images can be automatically detected using, for example, pattern recognition software.

### Audio-Recognition

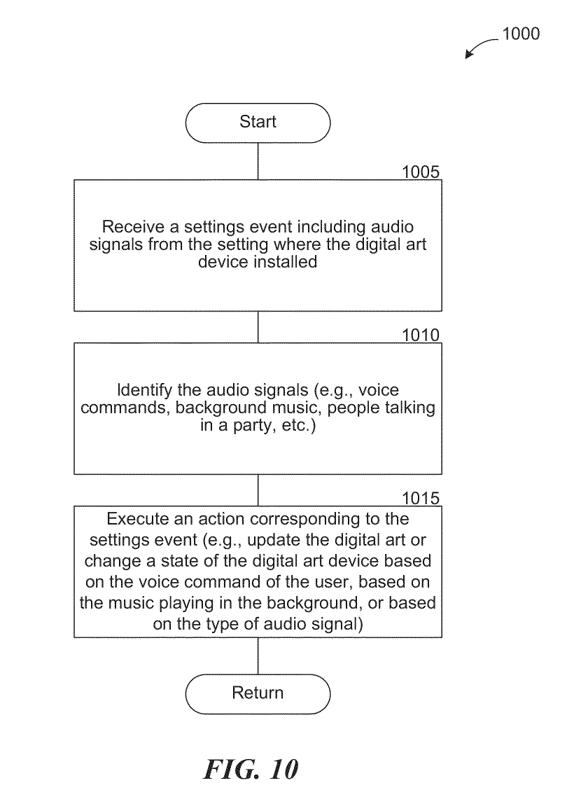

FIG. 10 is a flow diagram of a process 1000 of displaying a digital art using a digital art device of FIG. 1, consistent with an embodiment of a disclosed technique. In some embodiments, the process 1000 can be executed as part of the process indicated by blocks 515 and 520 of the process 500 of FIG. 5. At block 1005, the image processing module 350 receives a settings event from the event generation module 345 including audio data of the setting received from the audio recognition apparatus 320.

At block 1010, the image processing module 350 identifies the audio data. The audio data can include voice commands of the user, music playing in the setting, people talking in a party, sound or ambient noise in the setting, etc.

At block 1015, the image processing module 350 executes an action corresponding to the settings event. Executing the action associated with the settings event can include processing the digital art displayed at the digital art device 105 or changing a state of the digital art device based on the audio data received from the setting.

In some embodiments, processing the digital art can include transforming a first representation of the digital art that is displayed to a second representation of the digital art and displaying the second representation. In some embodiments, processing the digital art can include retrieving a new digital from the storage system and displaying the new digital art. For example, if the audio data indicates a party atmosphere or gathering of people, then the action can be to display a new digital art or change the representation of the digital art displayed at the device 105 that is more relevant to a party. In another example, if the audio data indicates shouting in the room, such as might emit from an argument, the action can be to display digital arts that are more “soothing.” In some embodiments, the image processing module 350 can identify the type of audio data using a sound analysis apparatus. The device 105 can respond to voice commands to alter its contents. For example, the user can issue a voice command to display a specified digital art from a specified artist and the image processing module 350 executes an action to display the specified digital art at the device 105.

Referring back to executing the action corresponding to the settings event in block 915, in some embodiments, executing the action associated with the event can include changing a state of the digital art device. For example, if the user issues a voice command for switching off the device, the action corresponding to the event can be to power off the device 105. In another example, if the audio data indicates a party, the action can be to change a color of the frame of the device 105 to a color that is more relevant to a party. An entity, e.g., the user of the device 105, an artist of a digital art, or a third party such as interior decorators can classify various arts, colors into different categories, themes, occasions, etc., which can be stored at a storage system accessible by the device 105, e.g., database 120, local storage device of the device 105.

### Intensity of Light

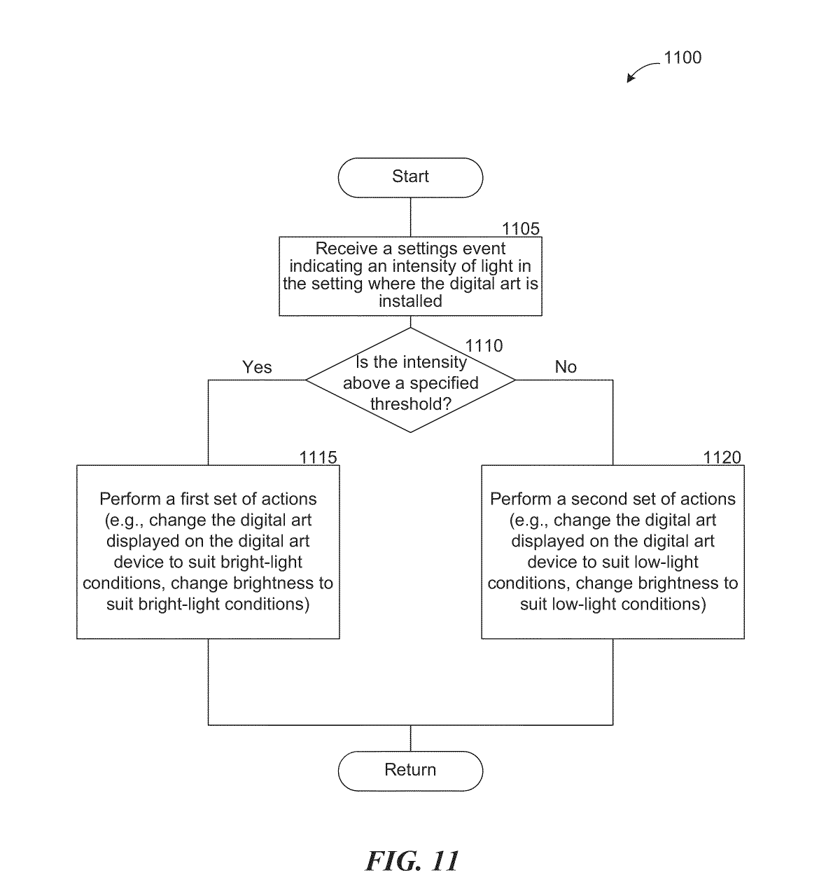

The device 105 can alter the digital art according to the lighting levels and conditions in the setting where the device 105 is installed. The device 105 can achieve this using the light intensity detection apparatus 330. FIG. 11 is a flow diagram of a process 1100 of displaying a digital art using a digital art device of FIG. 1, consistent with an embodiment of a disclosed technique. In some embodiments, the process 1100 can be executed as part of the process indicated by blocks 515 and 520 of the process 500 of FIG. 5. At block 1105, the image processing module 350 receives a settings event from the event generation module 345 including data regarding the intensity of light in the setting.

At block 1110, the image processing module 350 determines whether the intensity of light exceeds a specified threshold. Responsive to a determination that the intensity of light is above the specified threshold, at block 1115, the image processing module 350 executes a first action associated with the settings event. On the other hand, responsive to a determination that the intensity of light is below the specified threshold, at block 1120, the image processing module 350 executes a second action associated with the settings event. Executing the first action or the second action can include updating the digital art displayed in the device 105 and/or changing a state of the device 105 based on the intensity of light. For example, the intensity of light in a setting can change upon sunrise and/or sunset or during the day, and the device 105 can be configured to display different digital arts or different representations of a digital art at different times of the day as the day progresses. For example, a first representation of a particular digital art depicting sunrise in the background of mountains and light blue colored sky can be displayed upon sunrise. Similarly, upon sunset, a second representation of the particular digital art depicting a moon in the background of mountains and black sky can be displayed. The device 105 can be configured to display a digital art that is more appropriate to be displayed during the day, when the light is above a specified threshold, and automatically switch to another digital art during the night. The device 105 can also be configured to display different digital arts for different light intensity ranges.

Further, the properties of the device 105 can also be changed based on the lighting conditions. For example, the device 105 can be configured to increase the brightness of the screen during the day and decrease during the night.

### Color-Recognition

The device 105 can alter the digital art displayed on the device 105 to match the colors of the surrounding décor accessories in the setting where the device 105 is installed. For example, in an orange room, the digital arts to be displayed on the device 105 incorporate orange tints in the color palette. The device 105 can achieve this using the color-recognition apparatus 310.

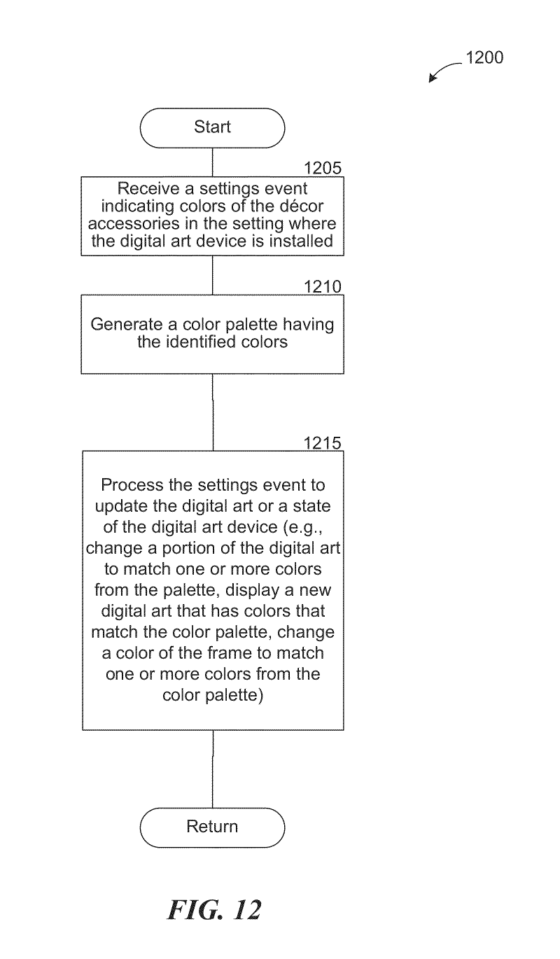

FIG. 12 is a flow diagram of a process 1200 of displaying a digital art using a digital art device of FIG. 1, consistent with an embodiment of a disclosed technique. In some embodiments, the process 1200 can be executed as part of the process indicated by blocks 515 and 520 of the process 500 of FIG. 5. At block 1205, the image processing module 350 receives a settings event from the event generation module 345 including data regarding colors of the décor accessories in the setting.

At block 1210, the image processing module 350 generates a color palette of the décor accessories.

At block 1215, the image processing module 350 executes an action corresponding to the settings event. Executing the action can include updating the digital art displayed in the device 105 to include one or more colors from the color palette and/or changing a state of the device 105 based on the color palette. The user can select one or more colors from the color palette and request the device 105 to display the digital art or change the state of the device 105 based on the selected colors. For example, if the wall of the room where the device 105 is installed on includes an orange color, the image processing module 350 alters/transforms the digital art displayed on the digital art device 105 to include an orange color or that contrasts with the orange color or that is similar to the orange color. In some embodiments, instead of altering the already displayed digital art, the image processing module 350 can display a new digital art that matches with one or more colors of the décor accessories of the setting. Further, when searching for digital arts, the user can then select colors from the palette in order to find images with those colors.

In another example, the image processing module 350 can change a color of the frame of the digital art device 105 based on the color palette. For example, the color of frame can be changed to match or contrast with the color of the wall, a closet near the device 105, etc.

### Orientation Detection

The device 105 can detect the orientation of the device using the orientation detection apparatus 325, and alter the digital art displayed in the device based on the orientations. FIG. 13 is a flow diagram of a process 1300 of displaying a digital art using a digital art device of FIG. 1, consistent with an embodiment of a disclosed technique. In some embodiments, the process 1300 can be executed as part of the process indicated by blocks 515 and 520 of the process 500 of FIG. 5. At block 1305, the image processing module 350 receives an orientation event indicating an orientation of the device 105.

At block 1310, the image processing module 350 processes the orientation event by executing action corresponding to the orientation event. Executing the action can include transforming the digital art displayed in the device 105 based on the orientation of the device 105, e.g., displaying the appropriate representations of the digital art. The digital art can include various representations for various orientations. For example, if the device 105 is tilted slightly, objects in a digital art would lean, fall or shift towards the downward slope, a fruit would move to one side of a basket, books would lean on a shelf, or a fish on a hook. In some embodiments, such effects can be achieved using gravitational physics techniques. Some digital arts can transform through 360 degrees, for example, a person's hair hanging “upwards” when the device 105 is tilted upside down.

### Real-Play

The device provides a feature referred to as “real play,” where art files that contain a digital record of all the brush strokes, or other artist tools, are played as a media file in order to reveal how the artist constructed the image to the smallest detail (pen stroke, brush flick etc.) right from scratch. For example, the user can watch the image being constructed as the artist constructed it, stroke-by-stroke, and pixel-by-pixel. This is not a time-lapse video or a replay of the artist creating the picture. In an embodiment, each “vector” stroke of the pen, including erasers, is stored. In addition to “time lapse” replay, a potential exists to watch a new piece of art being created in real time, that is, as the artist draws it. This might take place over hours, days, weeks or even months.

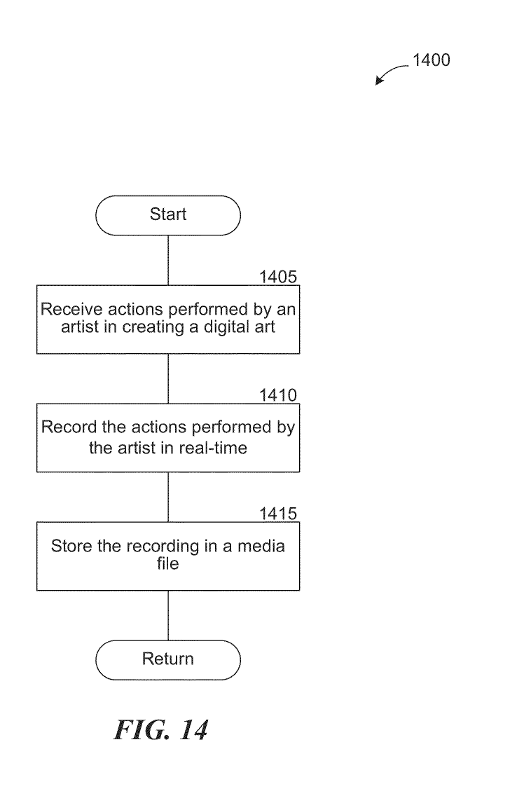

FIG. 14 is a flow diagram of a process 1400 of generating a real-play media file for a digital art, consistent with an embodiment of a disclosed technique. In some embodiments, the process 1400 can be executed in the environment of FIG. 1. At block 1405, the image processing module 350 receives actions performed by the artist in generating a digital art, e.g., paint brush strokes. At block 1410, the image processing module 350 records the actions performed by the artist in real-time, e.g., each “vector” stroke of the pen, including erasers, or other artist tools that the artist uses. At block 1415, the image processing module 350 stores the recording a media file. The media file will be of a specific format, e.g., of a format that can be played on the device 105, and includes all the actions performed by the artist in generating the digital art.

It should be noted that the creation of the media file is not restricted to the digital art device 105, and that the media files can be generated on other user devices such as a desktop, a laptop, a smartphone, a tablet, etc., using supporting applications, e.g., digital art creator app 215 that implement the above described functionality of the image processing module.

### Real-Time Updates

The device 105 can receive real-time updates via a wireless connection to the internet. For example, if the user has subscribed to a particular artist, the device 105 may display digital arts from the artist as and when the artist publishes the new digital arts. The device 105 can also receive any commands from the user wirelessly.

### Multi-Screen Display

In an embodiment, multiple digital art devices can be grouped on the wall to produce multi-screen displays, enabling a digital art to be shared across devices or a collection of matching digital arts to be shown. The digital arts to be displayed on the multiple screens in the multi-screen installation can be produced by the same artist, created specifically for multi-screen installations, or can be from different artists. In a multi-screen display, when adding a second device, the first device(s) automatically detects the newly added second device in the room and automatically adapts the image(s) to be displayed on the multiple devices including the second device.

### Mobile-Device Integration

The device 105 can also be controlled using mobile devices such as a smartphone, mobile phone, tablet computers, laptops, etc. For example, the user can control the device using an app on a smartphone or a tablet. For example, whilst out on a journey, the user might see an image of interest and take a picture using the smartphone camera. Upon return, the user can buy and request the image on their device 105 using an image-based search. Using an app on a smartphone or tablet, the user can move or cause the digital art displayed on the smartphone image to be displayed on the display of the device 105.

The user can hold their smartphone or tablet in front of the wall image and get a different view of that part of the image, that is, like a magnified or portal view into the larger art. This could include “X-ray” effects to look at objects hidden in the image.

### Other Features

Using transparent display technology, art can be incorporated into windows or mirrors. The art incorporated into windows can be used to transform the view from or into a room. Using cameras and appropriate software, “self-portraits” could be incorporated into mirror images or even wall décor. The self-portrait images could be animated, for example, using gaming engine technology to create all kinds of interesting possibilities, such as reflections that talk back.

In some embodiments, the device 105 is capable of showing digital arts that are larger than the physical size of the screen of the device 105. This could be used to show long-format landscape images that scroll left or right across the screen, either under user control or artist control.

In some embodiments, the device 105 can alter the digital art according to the temperature in the setting where the device 105 is installed. The device 105 can achieve this using the temperature detection apparatus 335. For example, if the temperature is below a specified threshold, e.g., below 40 degree Fahrenheit, the device 105 can be configured to show a digital art depicting a bright sunny landscape to give a soothing effect to the user. In another example, if the temperature is exceeds a specified threshold, e.g., above 100 degree Fahrenheit, the device 105 can be configured to show a digital art depicting a snow mountain.

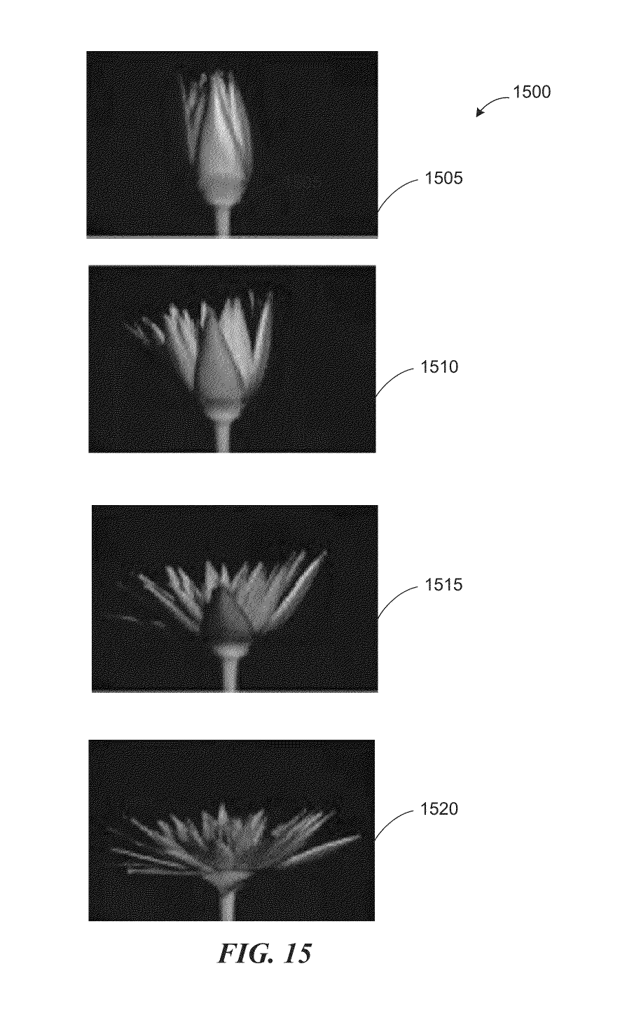

FIG. 15 is a block diagram of an example of a digital art, consistent with an embodiment of a disclosed technique. In some embodiments, the digital art 1500 can be displayed using the digital art device 105 of FIG. 1. A digital art is a collection of digital assets, e.g., multimedia files, which when displayed in a specified sequence and based on certain events can provide an interactive experience to a viewer. The digital art 1500 includes various digital assets, e.g., a first digital asset 1505, a second digital asset 1510, a third digital asset 1515, and a fourth digital asset 1520, which when displayed in a specified sequence and based on specified events, provides an interactive experience to a viewer, e.g., a bud blossoming into a flower. In some embodiments, each of the digital assets 1505-1520 is an image file. The events can occur due to human interaction and/or attributes of a setting where a computing device, e.g., the digital art device 105, is installed. For example, the events can include the events described at least with reference to FIGS. 6-13.

The digital assets 1505-1520 can be used to form various representations of the digital art 1500. The digital art 1500 can be programmed to transform from one representation to another, e.g., to provide an interactive experience to a viewer. For example, the digital art 1500 can have four representations, each of which corresponds to one of the four digital assets 1505-1520, i.e., each of the digital assets 1505-1520 can be portrayed as a separate representation of the digital art. The digital art 1500 can be programmed to transform into one or more of these four representations in a sequence and based on one or more events to depict various stages of a bud blossoming into a flower. For example, the digital art 1500 can be programmed to display the first digital asset 1505 as a first representation, transform to a second representation by displaying the second digital asset 1510 based on an event, e.g., expiry of a time interval, then transform to a third representation by displaying the third digital asset 1515 and then transform to the fourth representation by displaying the fourth digital asset 1520 to depict various stages of a bud blossoming into a flower.

In some embodiments, multiple digital assets can be used to portray a single representation of the digital art. For example, the first digital asset 1505 can portray a first representation of the digital art 1500 and the remaining three digital assets 1510-1520 can together form a second representation of the digital art 1500. The three digital assets 1510-1520 can be displayed as an image sequence, e.g., like a video where the digital assets 1510-1520 are displayed one after the other at a specified play rate. When an event for transformation is received, e.g., viewer's eye is focused on the bud displayed on the digital art device 105, the digital art 1500 automatically transforms from the first representation, e.g., the first digital asset 1505 depicting the bud, to the second representation, e.g., the digital assets 1510-1520, which are played like a video depicting the bud blossoming into the flower.

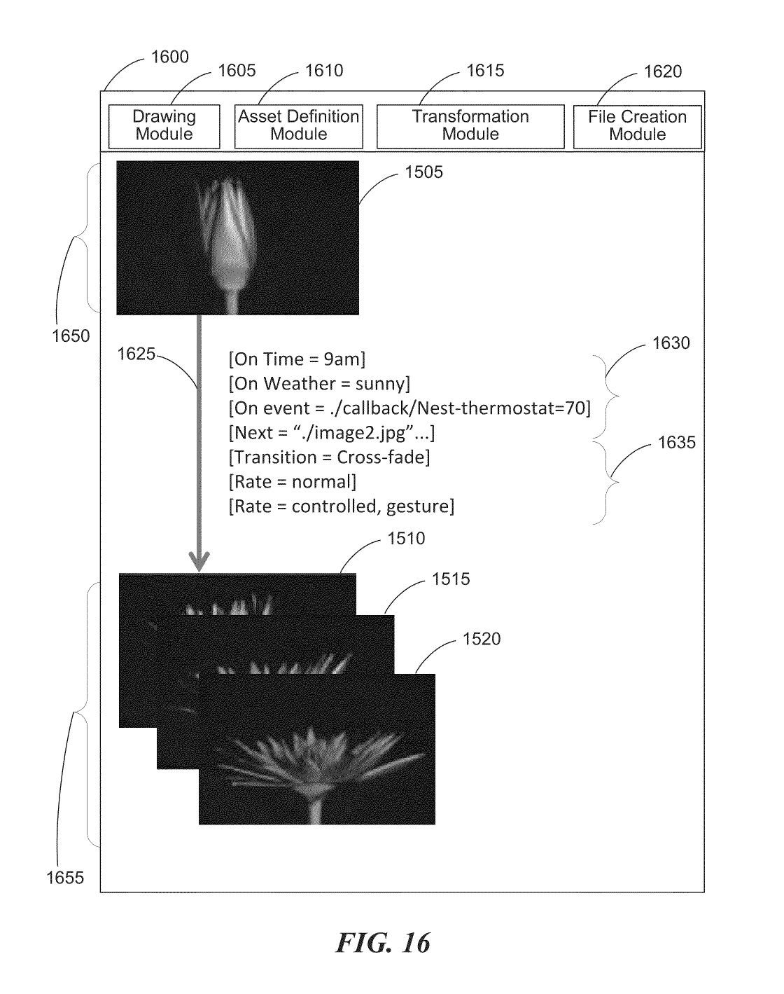

In some embodiments, the digital art creator app 215 of FIG. 2 facilitates the creation of the digital art 1500, including defining the transformations between the digital assets of the digital art 1500. Additional details with respect to creating the digital art creator app 215 are described at least with reference to FIG. 16 below.

FIG. 16 is a block diagram of a process for creating a digital art using the digital art creator app of FIG. 2, consistent with an embodiment of a disclosed technique. In some embodiments, the digital art creator app 215 includes a GUI, e.g., GUI 1600, using which a user, e.g., an artist, can generate the digital assets of a digital art and/or define transformations between representations of the digital art. The digital art creator app 215 includes various modules, e.g., a drawing module 1605, an asset definition module 1610, a transformation module 1615 and a file creation module 1620. In some embodiments, the drawing module 1605 includes a number of tools that can be used by the artist to create a digital asset of a digital art, such as the digital assets 1505-1520 of the digital art 1500 of FIG. 15. In some embodiments, the digital assets 1505-1520 are image files. Examples of the drawings tools can include tools for drawing and painting arts and tools for editing digital assets imported from a third party application. The drawing module 1605 can also include drawing tools provided by third party applications for creating digital assets. For example, the drawing module 1605 can include tools provided by Adobe Photoshop by Adobe Systems of San Jose, Calif. In some embodiments, the third party applications can be integrated with the digital art creator app 215 using a plug-in, an extension, etc., which are software modules that can be used to integrate two separate applications.

In some embodiments, the asset definition module 1610 includes a number of tools that can be used by the artist to perform various operations associated with an asset, e.g., importing digital assets from a third party application, specifying a source location of a digital asset, such as an uniform resource identifier (URI) of a digital asset, specifying properties of a digital asset, such as a size of the digital asset to be displayed. In some embodiments, the digital assets 1505-1520 can be fetched in real-time from the source location when the digital art 1500 is played or displayed on a computing device. The digital assets 1505-1520 can be fetched using various communication protocols, e.g., hyper-text transfer protocol (HTTP).

In some embodiments, the transformation module 1615 provides a set of tools that can be used by the artist to define transformations of the digital art 1500. For example, the transformation module 1615 enables the artist to define a transformation from the first representation 1650 of the digital art 1500 to a second representation 1655 of the digital art 1500 by drawing a navigational link 1625 between the first representation 1650 and the second representation 1655. The transformation module 1615 also enables the artist to specify various properties of a transformation, e.g., transformation properties 1630. The transformation module 1615 also enables the artist to specify various transition features of a transformation, e.g., transition features 1635.

In some embodiments, the file creation module 1620 provides a set of tools that can be used by the artist to store the digital art, e.g., digital art 1500, as a digital art file of a specified format in which all the digital assets for the digital art, the transformation definitions including the navigational links, events, transition features and any other necessary information to display the digital art are bundled or packaged together. Further, the source location of the digital assets within the digital art file can be expressed in a URI format relative to the digital art file storage location. In some embodiments, the digital art file can be an executable file which when executed on a computing device, e.g., a laptop, a desktop, a smartphone, a tablet, the digital art device 105 of FIG. 1, displays the digital art based on the transformations defined using the digital art creator app 215. The executable file may be executed independently on the computing device, i.e., without the need for a specific application to execute the executable file. In some embodiments, the file is of a specific format, e.g., “.art” format, which can require a specific application, e.g., digital art player app 135, that is capable of displaying the digital art based on the transformations defined in the digital art creator app 215.

In some embodiments, defining transformations can include one or more of defining a sequence in which the various digital assets are to be displayed, and defining the events based on which the transformations between the assets are to occur. For example, the GUI 1600 illustrates a transformation for the digital art 1500 from a first representation 1650 to a second representation 1655. The user can define the transformation from the first representation 1650 to the second representation 1655 by drawing a navigational link 1625 or a connector from the first representation 1650 to the second representation 1655. The navigational link 1625 includes a transformation property, e.g., “Next=‘./image2.jpg’”, that has information regarding a digital asset that is to be displayed upon transformation from the first representation 1650 to the second representation 1655. If the second representation 1655 has multiple digital assets, then the location of all those digital assets may be included in the transformation property. Note that the first representation 1650 is portrayed using a single digital asset, e.g., first digital asset 1505, and the second representation 1655 is portrayed using multiple digital assets, e.g., digital assets 1510-1520. Further, in some embodiments, the second representation 1655 can be portrayed using a video digital asset that contains a video of the bud blooming into a flower as depicted by digital assets 1510-1520.

In some embodiments, the different representations of the digital art 1500 can be depicted using a single digital asset, e.g., a CGI file. The single CGI file can depict various stages of a bud blooming into a flower as depicted by the digital assets 1505-1520. In such cases, the transformation property “Next” in the transformation properties can specify a representation or a state identifier, which can be used to locate the particular representation of the digital art 1500 in the CGI file. In some embodiments, the transformation property “Next” can specify an action, e.g., set of instructions, to be performed by the CGI file to generate the identified representation. For example, the actions can include the actions described at least with reference to FIGS. 6-13.

Next, the artist can specify the conditions or the events based on which the transformation has to occur, as transformation properties, e.g., transformation properties 1630, of the navigational link 1625. In the transformation properties 1630, the event “On Time=9 am” indicates that the transformation is to occur at “9 am”, that is, the digital art 1500 is to transform from the first representation 1650 to the second representation 1655 at “9 am.” Similarly, the event “On Weather=Sunny” indicates that the transformation is to occur when the weather is sunny. In some embodiments, the artist can define how the weather is determined. For example, the artist can determine the weather as “sunny” as a function of intensity of light and/or a room temperature of a setting where a computing device displaying the digital art 1500 is installed. In some embodiments, the intensity of light and/or the room temperature of the setting can be determined using various sensors associated with the computing device, e.g., sensors of digital art device 105. A user, e.g., a user associated with the digital art device 105 can further customize the function for determining whether the weather is “sunny”, e.g., by changing the values of the intensity of light and/or the room temperature. In some embodiments, the user can perform such customization using the digital art player app 135.

The artist can also define transition features, e.g., transition features 1635, of a transformation. The transition features can include audio and/or visual effects, such as a cross fade effect, burns effect, a speed at which a video is to be played, etc. In the transition features 1635, the transition feature “transition=cross-fade” indicates that the first representation 1650 transforms into the second representation 1655 with a cross-fade effect. The transition features 1635 includes a play head rate transition feature “Rate=normal” which indicates that the digital assets 1510-1515 are to be played like a video at a normal rate. The artist can define multiple values for the video rate, e.g., slow, fast, medium. In the transition features 1635, the transition feature “Rate=controlled, gesture” indicates that the rate at which the digital assets 1510-1515 are played can be controlled by a gesture made by a viewer of the digital art 1500, e.g., gesture for pausing, rewinding, forwarding.

Note that the events and the transition features specified above are just examples. The digital art creator app 215 enables the artist to specify various other events and transition features. Further, a viewer of the digital art can also define and/or customize at least some events, e.g., using the digital art player app 135.

Note that the GUI 1600 can include various other tools for performing other art related functions. The GUI 1600 can provide a “drag and drop” GUI in which the artist can be define transformations by performing drag and drop operations. For example, the GUI 1600 can load the assets from a location specified by the artist into a first portion of the GUI 1600 (not illustrated) and the artist can drag the assets he would like to create a digital art with and drop them into a second portion of the GUI 1600 (not illustrated) to define the transformation. The artist can define the transformation by creating navigational links, e.g., using connectors provided in the transformation module 1615, between the digital assets in the second portion of the GUI 1600. In some embodiments, the navigational link can also defined as a data object in the GUI 1600, where the artist can specify attributes of the transformation such as transformation identification (ID) of the transformation, a source digital asset, a destination digital asset, events, transition features, etc., as attributes of the data object. In some embodiments, each transformation of the digital art has a unique transformation ID.

The GUI 1600 depicts a single transformation of the digital art 1500. However, the digital art can have a number of transformations between various digital assets and/or representations. For example, the digital art can have a third representation and a fourth representation, and transformations can be defined to those representations from any of the representations. For example, the third representation can be to display the flower from the second representation in a color dependent on a color of the light in the setting. In some embodiments, the color of the light can be determined by a sensor associated with the computing device displaying the art, e.g., sensors of the digital art device 105. In some embodiments, the computing device or the digital art player app 135 can be configured to obtain the color of the light from lighting bulbs, e.g., hue personal wireless lighting bulbs by Philips of Amsterdam, Netherland. When the digital art player app 135 identifies the change in the light color, it can transform the digital art from the second representation to the third representation, which depicts the flower in a color determined based on the color of the lighting of the setting.

Although the GUI 1600 depicts just a single transformation from a first digital asset 1505, a digital asset can have a number of transformations, each of them represented by separate navigational links and transforming to different destination digital assets of the digital art. Further, different navigational links can be associated with different events. For example, the digital art can transform from the first representation to the second representation based on a first set of events and from the first representation to the third representation based on a second set of events.

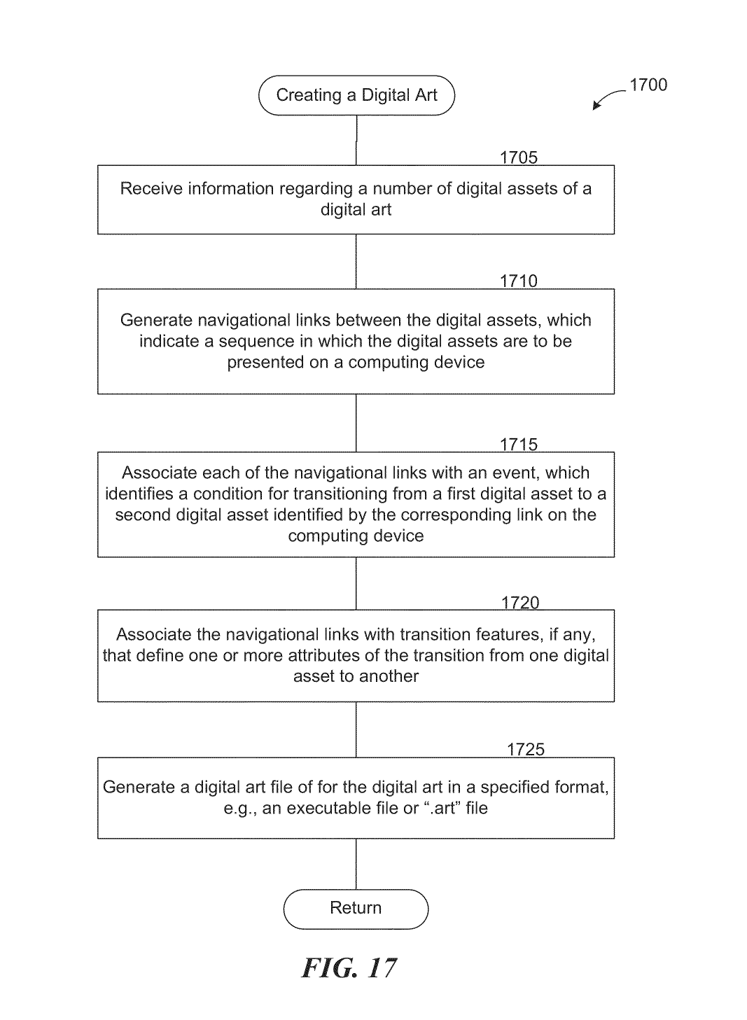

FIG. 17 is a flow diagram of a process 1700 for creating a digital art using a digital art creator app of FIG. 2, consistent with various embodiments. In some embodiments, the process 1700 can be implemented in the digital art creator app 215 as illustrated in FIG. 16. In some embodiments, the digital art creator app 215 can be implemented on the digital art device 105 of FIG. 1, e.g., using the image generation module 365 of the digital art device 105 illustrated in FIG. 3. In some embodiments, the digital art creator app 215 can be implemented on a computing device, such as, a laptop, a desktop, a smartphone, a tablet or any other device that is capable of executing the digital art creator app 215, e.g., by implementing the image generation module 365 on the computing device. In some embodiments, the image generation module 365, whether implemented on the computing device or on the digital art device 105, performs the functionalities of at least some of the modules 1605-1620 to generate the digital art.

At block 1705, the asset definition module 1610 of the digital art creator app 215 receives information regarding digital assets of a digital art, e.g., information regarding digital assets 1505-1520 of the digital art 1500. The information can include a source location of the digital assets. The source location can be a location of the digital asset on a local storage device of the computing device on which the digital art creator app 215 is executing or a location of the digital asset in a network, such as Internet. The location of the digital asset in the network can be specified using an URI.

At block 1710, the transformation module 1615 defines transformations between the digital assets of the digital art. In some embodiments, a transformation between the digital assets is defined by generating a navigational link between the digital assets, which indicate a sequence in which the digital assets are to be presented on a computing device on which the digital art is viewed. The navigational link includes a source digital asset, which depicts a digital asset from which the digital art is to be transformed, and a destination digital asset, which depicts a digital asset to which the digital art is to be transformed. For example, as illustrated in FIG. 16, the navigational link 1625 defines a transformation between a first representation 1650 of the digital art 1500, which is portrayed using the first digital asset 1505, and a second representation 1655, which is portrayed using the digital assets 1510-1520. The navigational link 1625 indicates that the digital assets 1510-1520 are to be displayed subsequent to the first digital asset 1505.

At block 1715, the transformation module 1615 associates each of the navigational links with one or more events, which identifies a condition for transitioning from the source digital asset to the destination digital asset of the corresponding navigational link. An event can be caused due to a human interaction with the digital art and/or a change in an attribute of a setting where a computing device displaying the digital art is installed. An example event can include a gesture made a by a viewer at the digital art, a change in room temperature of the setting, a change in intensity of light, etc.

At block 1720, the transformation module 1615 associates a navigational link with transition features. In some embodiments, the transition features define one or more attributes of a transition, e.g., audio effects and/or visual effects of a transition from one digital asset to another. For example, in the transition features 1635, the transition feature “transition=cross-fade” indicates that the first representation 1650 transforms into the second representation 1655 with a cross-fade effect.

After the transformations are defined, at block 1725, the file creation module 1620 stores the digital art in a specified file format. For example, the digital art file can be an executable file which, when executed on the computing device, presents the digital assets of the digital art in the specified sequence based on the navigational links between the digital assets and based on the events with which the navigational links are associated. In some embodiments, the executable file can be executed on the computing device without the need for a specific application to execute the executable file. In another example, the digital art file can be of a specific format, e.g., “.art” format, which can be executed using a specific application, e.g., digital art player app 135, that is programmed to or capable of executing such digital art files.

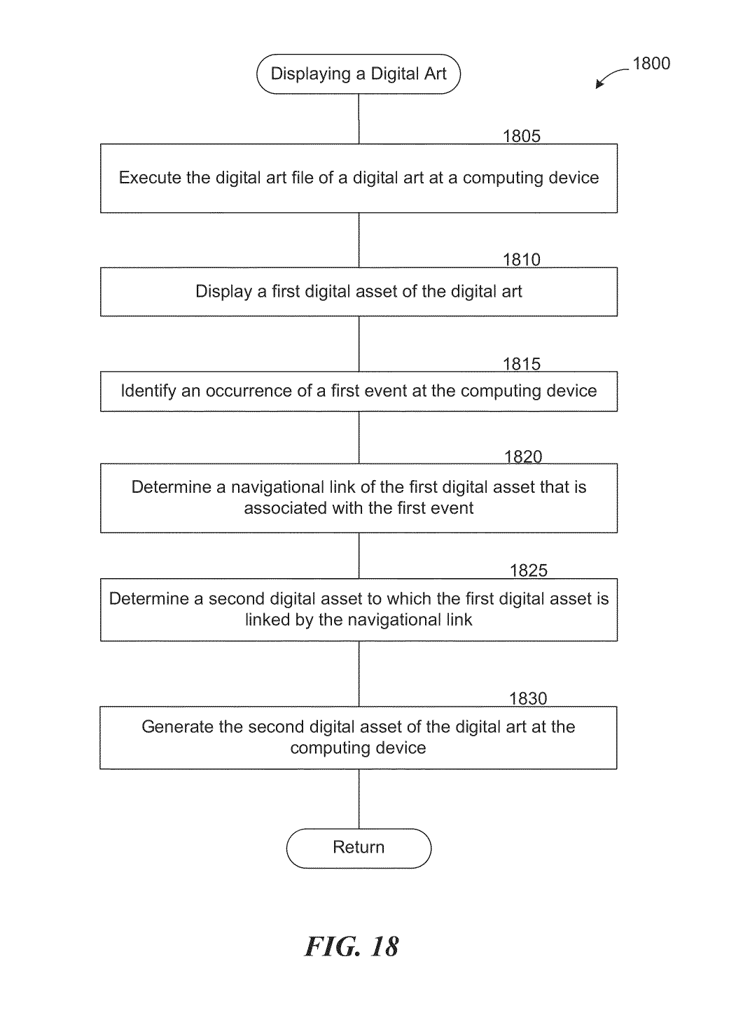

FIG. 18 is a flow diagram of a process 1800 for displaying a digital art that is generated using a digital art creator app of FIG. 2, consistent with various embodiments. In some embodiments, the process 1800 can be implemented using the digital art player app 135 of FIG. 1. In some embodiments, the digital art player app 135 can be implemented on the digital art device 105 of FIG. 1, e.g., using at least some of the modules 340-365 of the digital art device 105 illustrated in FIG. 3. In some embodiments, the digital art player app 135 can be implemented on a computing device, such as, a laptop, a desktop, a smartphone, a tablet, e.g., by implementing the modules 340-365 on the computing device.

The user can download a digital art file, e.g., generated as described in block 1725 of FIG. 17, to the computing device where the user wishes to the display the digital art. At block 1805, the image processing module 350 executes the digital art file at the computing device to display the digital art. In some embodiments, the image processing module 350 may request the image retrieving module 340 to obtain a digital asset of the digital art, e.g., a first digital asset of 1505 of digital art 1500, from a source location of the digital asset specified in the digital art file.

After the image retrieving module 340 retrieves the first digital asset, at block 1810, the display module 355 displays the first digital asset of the digital art on a display screen of the computing device.

At block 1815, the event generation module 345 identifies an occurrence of an event at the computing device. The event can be caused due to a human interaction with the digital art displayed on the computing device or due to a change in an attribute of a setting where the computing device is installed. For example, the event can be caused due to a change in weather and/or a room temperature of the setting.

At block 1820, the image processing module 350 determines a navigational link of the first digital asset that is associated with the event, e.g., navigational link 1625 associated with change in weather to “sunny.” As described earlier, a digital asset can be associated with multiple navigational links which transform to different representations of the digital art. Further, different navigational links can be associated with different events.

At block 1825, the image processing module 350 determines a second digital asset to which the first digital asset is linked by the navigational link. That is, the image processing module 350 determines one or more digital assets to which the first digital asset is to be transformed. For example, the image processing module 350 inspects the transformation properties of the navigational link to determine the next digital asset to be displayed at the computing device. In some embodiments, if a representation of the digital art is portrayed using multiple digital assets, e.g., second representation 1655 in FIG. 16, the digital art is transformed to those multiple digital assets.

After the image processing module 350 determines the second digital asset to displayed, the image retrieving module 340 retrieves the second digital asset from the location specified in the digital art file and, at block 1830, the display module generates the second digital asset of the digital art at the computing device. The displaying the second digital asset can include applying any transition features, e.g., transition features 1635, associated with the transformation. For example, as illustrated in FIG. 16, the second representation 1655 is associated with transition features such as “cross-fade” effect and a play rate of “rate=normal”. So when the first digital asset is transformed to the digital assets 1510-1520, which are played one after the other as a video at a normal play rate, the first digital asset cross-fades into the digital assets 1510-1520.

### Example Processing System

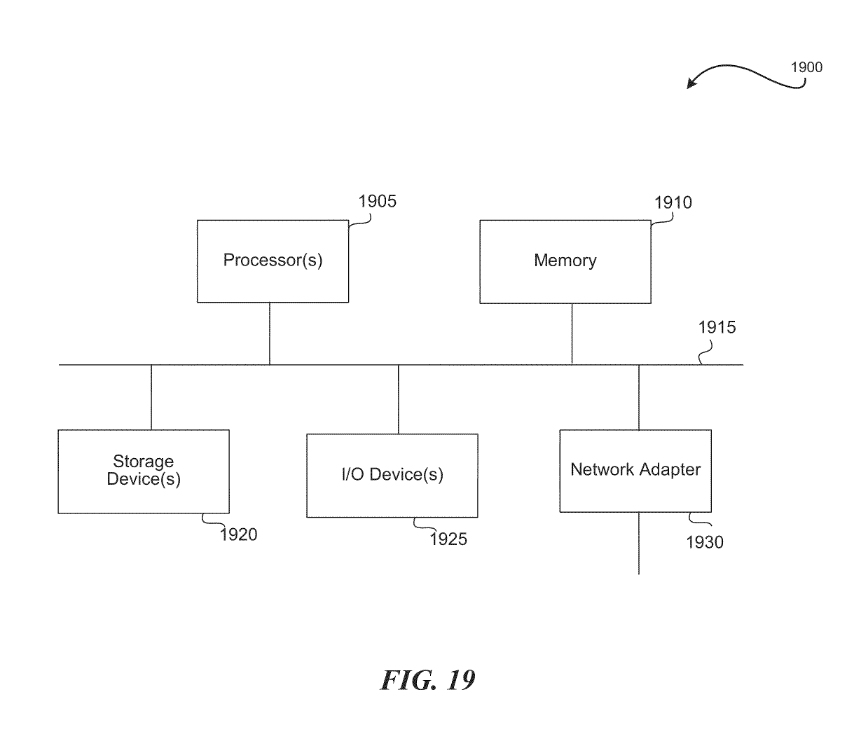

FIG. 19 is a block diagram of a computer system or a processing system as may be used to implement features of some embodiments. The computer system may perform various operations disclosed above, and store various information generated and/or used by such operations. The processing system 1900 is a hardware device on which any of the entities, components, modules or services depicted in the examples of FIGS. 1-18 (and any other components described in this specification) can be implemented. The processing system 1900 includes one or more processors 1905 and memory 1910 coupled to an interconnect 1915. The interconnect 1915 is shown as an abstraction that represents any one or more separate physical buses, point to point connections, or both connected by appropriate bridges, adapters, or controllers. The interconnect 1915, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 1905 is/are the central processing unit (CPU) of the processing system 1900 and, thus, control the overall operation of the processing system 1900. In certain embodiments, the processor(s) 1905 accomplish this by executing software or firmware stored in memory 1910. The processor(s) 1905 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 1910 is or includes the main memory of the processing system 1900. The memory 1910 represents any form of random access memory (RAM), read-only memory (ROM), flash memory, or the like, or a combination of such devices. In use, the memory 1910 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 1905 through the interconnect 1915 are a network adapter 1930, a storage device(s) 1920 and I/O device(s) 1925. The network adapter 1930 provides the processing system 1900 with the ability to communicate with remote devices, over a network and may be, for example, an Ethernet adapter or Fibre Channel adapter. The network adapter 1930 may also provide the processing system 1900 with the ability to communicate with other computers within the cluster. In some embodiments, the processing system 1900 may use more than one network adapter to deal with the communications within and outside of the cluster separately.

The I/O device(s) 1925 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 1910 can be implemented as software and/or firmware to program the processor(s) 1905 to carry out actions described above. In certain embodiments, such software or firmware may be initially provided to the processing system 1900 by downloading it from a remote system through the processing system 1900 (e.g., via network adapter 1930).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 1520 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The term “logic”, as used herein, can include, for example, programmable circuitry programmed with specific software and/or firmware, special-purpose hardwired circuitry, or a combination thereof.

Although the present invention has been described with reference to specific exemplary embodiments, it will be recognized that the invention is not limited to the embodiments described, but can be practiced with modification and alteration within the spirit and scope of the embodiments described. Accordingly, the specification and drawings are to be regarded in an illustrative sense rather than a restrictive sense.

I/We claim:

1. A computer-implemented method, comprising:
receiving information regarding a plurality of digital assets of a digital art, the plurality of digital assets to be displayed at a computing device in a specified sequence that is determined based on a plurality of events;
identifying a first digital asset of the plurality of digital assets and a second digital asset of the plurality of digital assets to be generated on the computing device;
generating a first navigational link from the first digital asset to the second digital asset, the first navigational link indicating that the second digital asset is to be generated after the first digital asset;
associating the first navigational link with an event, wherein the event identifies a condition for transitioning from the first digital asset to the second digital asset on the computing device, the first navigational link being one of a plurality of navigational links that are generated by linking two or more of the plurality of digital assets, each of the plurality of navigational links associated with one or more of the plurality of events, the plurality of navigational links defining a transformation between the plurality of digital assets; and
generating an executable file for the digital art that when executed on the computing device generates the plurality of digital assets in the specified sequence based on the plurality of navigational links and the plurality of events with which the plurality of navigational links are associated.

2. The computer-implemented method of claim 1, wherein the first digital asset is associated with a set of the navigational links, each of the navigational links associated with different events and defining a transformation from the first digital asset to a different digital asset of the plurality of digital assets.

3. The computer-implemented method of claim 1 further comprising:
executing the executable file to display the first digital asset at the computing device;
receiving a first event at the computing device;
determining a specified navigational link of a set of the navigational links of the first digital asset that is associated with the first event;
determining a third digital asset of the plurality of digital assets to which the specified navigational link is linked; and
generating the third digital asset of the digital art at the computing device.

4. The computer-implemented method of claim 1, wherein an digital asset of the plurality of digital assets includes a multimedia file.

5. The computer-implemented method of claim 1, wherein associating the first navigational link with the event further includes:
associating the first navigational link with a plurality of features of a transition between the first digital asset and the second digital asset, the features defining one or more attributes of the transition.

6. The computer-implemented method of claim 5, wherein the plurality of features include a play head feature that defines a speed at which a video digital asset is to be played.

7. The computer-implemented method of claim 1, wherein the executable file is executable using a digital art player application that is capable of processing the navigational links and events.

8. The computer-implemented method of claim 1, wherein the digital art is generated on the computing device by executing the executable file.

9. The computer-implemented method of claim 1, wherein the event is a real-time event.

10. The computer-implemented method of claim 9, wherein the real-time event is triggered based on at least one of a time of a day, an intensity of light in a setting where the computing device is installed, a room-temperature of the setting, audio signals in the setting, a presence or absence of a user in the setting, or a gesture from the user.

11. The computer-implemented method of claim 9, wherein the real-time event is triggered based on data received from a plurality of sensors in the computing device.

12. The computer-implemented method of claim 1, wherein the information regarding the plurality of digital assets includes a source location of each of the plurality of digital assets.

13. The computer-implemented method of claim 12, wherein the source location of at least one of the plurality of digital assets includes a Uniform Resource Identifier (URI) of the at least one of the plurality of digital assets.

14. The computer-implemented method of claim 1, wherein generating the executable file includes packaging the plurality of digital assets and the plurality of navigational links that defines transformations between the plurality of digital assets in the executable file.

15. A computer-readable storage medium storing computer-readable instructions, comprising:
instructions for generating a graphical user interface (GUI) for creating a digital art, the digital art being a collection of a plurality of digital assets that are to be displayed on a computing device in a specified sequence;
instructions for generating, using the GUI, a plurality of navigational links from a first digital asset of the plurality of digital assets to a set of the plurality of digital assets, wherein each of the plurality of navigational links indicates a next one of the plurality of digital assets to be generated on the computing device subsequent to the first digital asset, and wherein the plurality of navigational links are linked to different digital assets of the plurality of digital assets;
instructions for associating, using the GUI, each of the navigational links with one or more events, wherein each of the one or more events identifies a condition for transitioning from the first digital asset to one of the set of the plurality of digital assets;
instructions for generating, using the GUI, an executable file that is executable in a digital art player application executing on the computing device and that is configured to output the plurality of digital assets on the computing device in the specified sequence, the specified sequence determined based on a set of navigational links between the plurality of digital assets and a plurality of events associated with the set of navigational links.

16. The computer-readable storage medium of claim 15, wherein the instructions for generating the plurality of navigational links from the first digital asset to the set of the plurality of digital assets includes:
instructions for associating a first navigational link of the plurality of navigational links with a plurality of transition features, each of the plurality of transition features defining an attribute of a transition from the first digital asset to a second digital asset of the set of the plurality of digital assets identified by the first navigational link.

17. The computer-readable storage medium of claim 16, wherein the attribute of the transition includes an audio effect of the transition.

18. The computer-readable storage medium of claim 16, wherein the attribute of the transition includes a video effect of the transition.

19. The computer-readable storage medium of claim 15, wherein the executable file includes:
instructions for generating the first digital asset on the computing device in response to executing the executable file using the digital art player application,
instructions for determining an occurrence of a specified event at the computing device,
instructions for identifying a specified navigational link of the plurality of navigational links with which the specified event is associated, and
instructions for generating, at the computing device, a specified digital asset of the set of the plurality of digital assets that is linked to the first digital asset by the specified navigational link.

20. The computer-readable storage medium of claim 19, wherein the instructions for determining the occurrence of the specified event includes instructions for triggering the specified event based on data received from a plurality of sensors associated with the computing device.

21. The computer-readable storage medium of claim 19, wherein the instructions for generating the specified digital asset includes:
instructions for transitioning from the first digital asset to the specified digital asset based on a transition feature associated with the specified navigational link.

22. The computer-readable storage medium of claim 15, wherein an digital asset of the plurality of digital assets includes at least one of (a) an image file, (b) an audio file, (c) a video file, (d) a computer generated imagery (CGI) file, or (e) an animation.

23. The computer-readable storage medium of claim 15, wherein the instructions for generating the executable file includes instructions for packaging the plurality of digital assets and the set of navigational links that defines transformations between the plurality of digital assets in the executable file.

24. A system, comprising:
a processor;
a first module configured to receive information regarding a plurality of digital assets of a digital art, the plurality of digital assets to be displayed at a computing device in a specified sequence that is determined based on a plurality of events occurring at the computing device;
a second module configured to generate a plurality of navigational links that defines a transformation between the plurality of digital assets in the specified sequence, each of the navigational links including a plurality of navigational link properties, wherein the plurality of navigational link properties includes:
a first navigational link property that specifies one of the plurality of digital assets as a source of the corresponding navigational link,
a second navigational link property that specifies a second one of the plurality of digital assets as a destination of the corresponding navigational link, and
a third navigational link property that specifies an event, wherein the event is a condition for activating the corresponding navigational link,
wherein the digital art is transitioned from the source of the corresponding navigational link to the destination of the corresponding navigational link upon activation of the corresponding navigational link; and
a third module configured to generate an executable file for the digital art that when executed on the computing device generates the plurality of digital assets in the specified sequence based on the plurality of navigational links.

25. The system of claim 24, wherein the information regarding the plurality of digital assets includes a source location of each of the plurality of digital assets.

26. The system of claim 25, wherein the first module is further configured to obtain, during execution of the executable file, a first digital asset of the plurality of digital assets from the corresponding source location when the digital art transitions to the first digital asset.

27. The system of claim 24 further comprising:
a fourth module to execute the executable file to display the digital art at the computing device in the specified sequence.

28. The system of claim 27, wherein the fourth module is configured to execute the executable file by:
determining an occurrence of a specified event at the computing device,
identifying a specified navigational link of the plurality of navigational links with which the specified event is associated, and
generating, at the computing device, a specified digital asset of the plurality of digital assets that is linked to the first digital asset by the specified navigational link.

29. The system of claim 24, wherein the third module is configured to generate the executable file by packaging the plurality of digital assets and the plurality of navigational links that defines transformations between the plurality of digital assets in the executable file.

30. A computer-implemented method, comprising:
receiving information regarding a plurality of digital assets of a digital art, the plurality of digital assets to be displayed at a computing device in a specified sequence;
generating a plurality of navigational links for a first digital asset of the plurality of digital assets, each of the plurality of navigational links specifying one of the plurality of digital assets as a destination digital asset of the corresponding navigational link, each of the plurality of navigational links causing the digital art to transition from the first digital asset to the destination digital asset upon an occurrence of a first event of a plurality of events that is associated with the corresponding navigational link, each of the plurality of navigational links associated with one or more of the plurality of events; and
generating an art file of a specified file format for the digital art that when executed on the computing device causes the computing device to:
display one or more of the plurality of digital assets of the digital art, and transition between the plurality of digital assets in a sequence based on the plurality of events and the plurality of navigational links.

31. The computer-implemented method of claim 30, wherein generating the art file includes packaging the plurality of digital assets and the plurality of navigational links that defines transformations between the plurality of digital assets in the art file.
